(19) United States
(12) Patent Application Publication
(10) Pub. No.: US 2026/0289177 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/567,010

(22) Filed: Mar. 14, 2026

(30) Foreign Application Priority Data
Mar. 19, 2025 (JP) 2025-045155

(51) Int. Cl. G06F 40/40; G06F 16/3329; G06F 40/284; G06F 40/30; G06N 3/0475

(52) U.S. Cl. CPC G06F 40/40; G06F 16/3329; G06F 40/284; G06F 40/30; G06N 3/0475

(57) ABSTRACT

A system includes a processor that is configured to receive an inquiry from a user, analyze the received inquiry by using a natural language processing technique to understand an intent of the inquiry, refer to an internal information database based on a result of the analysis and acquire related information from the internal information database, generate a prompt that instructs a generative AI model to generate an appropriate answer based on the acquired information, cause the appropriate answer to be generated by the generative AI model based on the generated prompt, transmit the generated answer to the user, analyze an emotion of the user, and adjust a response according to the emotion of the user.

### CROSS-REFERENCE TO RELATED APPLICATION

This application is based on and claims priority under 35 USC 119 from Japanese Patent Application No. 2025-045155 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional interactive AI systems for customer support suffer from several limitations. First, many systems cannot reliably understand the intent of a user's inquiry, because they lack robust natural language processing and structured intent analysis. As a result, such systems frequently provide irrelevant or insufficient answers, forcing a human operator to intervene and increasing operational cost. Second, conventional systems often retrieve information from internal databases in a rule-based or keyword-based manner, without flexibly combining the retrieved information into a context-appropriate answer, which leads to fragmented or overly generic responses. Third, even when generative AI models are introduced, they are not always controlled by explicit prompts generated on the basis of structured analysis results and internal data, so the quality, accuracy, and consistency of the generated answers cannot be guaranteed. Fourth, most existing systems do not take into account the emotional state of the user in real time, and therefore cannot adapt the tone, politeness level, or content of the responses to calm frustrated users or to appropriately respond to different emotional conditions. Consequently, there is a need for a system that can accurately analyze user inquiries by natural language processing, retrieve and incorporate relevant internal information, generate explicit prompts to control a generative AI model, and further analyze user emotion to adjust responses in a manner that improves user satisfaction and reduces the burden on human operators.

### SUMMARY

In order to solve the above-mentioned problems, a system according to at least one embodiment of the present invention comprises a processor, wherein the processor is configured to receive an inquiry from a user and to analyze the received inquiry by using a natural language processing technique to understand an intent of the inquiry. The processor is further configured to refer to an internal information database based on a result of the analysis and to acquire related information from the internal information database, and to generate a prompt that instructs a generative AI model to generate an appropriate answer based on the acquired information. The processor is configured to cause the appropriate answer to be generated by the generative AI model based on the generated prompt, and to transmit the generated answer to the user. In addition, the processor is configured to analyze an emotion of the user and to adjust a response according to the emotion of the user. By configuring the processor in this way, the system can accurately interpret user intent through natural language processing, can obtain suitable internal information corresponding to the interpreted intent, can generate explicit prompts that constrain and guide the generative AI model toward accurate and context-appropriate answers, and can further modify the wording, tone, and content of the responses according to the emotional state of the user. Thus, the system enables automatic generation of high-quality answers, improves user satisfaction by emotion-aware response control, and reduces the need for manual intervention by human operators.

The term “system” refers to a combination of hardware and software components including at least one processor configured to execute the processing described in the claims.

The term “processor” refers to one or more hardware processing units, such as a central processing unit (CPU), a graphics processing unit (GPU), or a dedicated accelerator, that execute computer-readable instructions to perform the functions described in the claims.

The term “user” refers to a human operator or customer who interacts with the system by inputting inquiries and receiving responses.

The term “inquiry” refers to a natural-language message, question, or request transmitted from the user to the system.

The term “natural language processing technique” refers to a computational method or algorithm for analyzing and understanding human language text, including at least one of tokenization, syntactic analysis, semantic analysis, intent detection, and entity recognition.

The term “intent of the inquiry” refers to the purpose, objective, or meaning that the user seeks to achieve or obtain through the inquiry, as interpreted by the system.

The term “internal information database” refers to a data storage resource managed within an organization, storing technical information, product information, service information, or other knowledge to be referenced by the system when generating answers.

The term “related information” refers to one or more data items or documents retrieved from the internal information database that are determined to be relevant to the intent of the user's inquiry.

The term “prompt” refers to a structured text or data representation generated by the processor, which provides instructions, context, and constraints to a generative AI model for generating an answer.

The term “generative AI model” refers to a machine learning model capable of generating natural-language text based on an input prompt, such as a large language model or other generative neural network.

The term “appropriate answer” refers to a natural-language response generated by the generative AI model that is relevant to the user's inquiry, consistent with the related information, and suitable in accuracy and content.

The term “transmit the generated answer to the user” refers to sending the generated answer from the system to a terminal or interface used by the user, through a communication network or other communication means.

The term “emotion of the user” refers to an estimated emotional state of the user, such as anger, frustration, satisfaction, neutrality, or other affective conditions, inferred from the user's input and interaction.

The term “adjust a response according to the emotion of the user” refers to modifying at least one of the wording, tone, level of detail, or structure of the generated answer based on the detected emotional state of the user.

The term “question from a customer” refers to an inquiry expressed in natural language by the user in the role of a customer of a product or service provided by an organization operating the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

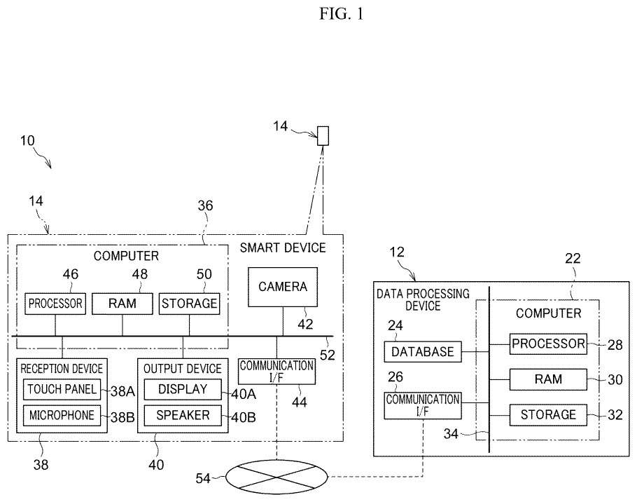

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

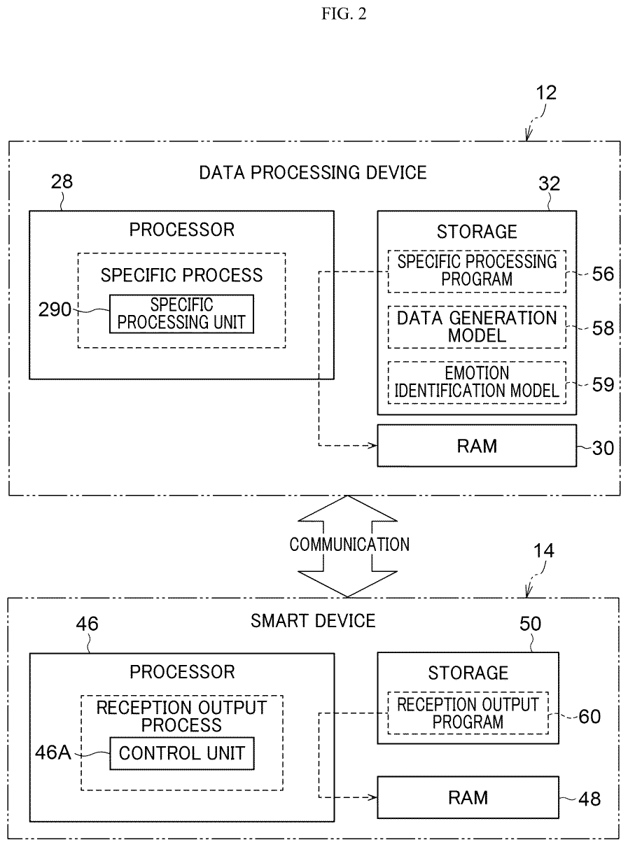

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems that provide answers to user inquiries typically rely either on fixed rule-based templates or on direct invocation of a generative artificial intelligence model using only the raw user input. In a rule-based approach, the system hard-codes patterns and responses, which limits coverage and makes it difficult to adapt to new products, error conditions, or document structures without extensive manual engineering. In a direct generative approach, the system often passes the user's inquiry as-is to a generative artificial intelligence model, without robust intent recognition, structured retrieval of internal data, or systematic control of the model's behavior. As a result, such systems may generate answers that are incomplete, inconsistent with authoritative internal data, or unnecessarily verbose or terse.

From a computer-technology standpoint, these conventional systems do not efficiently utilize computational resources for natural language processing, data retrieval, and answer generation. A server may repeatedly invoke heavy-weight generative models on ill-structured prompts, causing unnecessary processor and memory load and increasing latency.

Furthermore, the absence of an explicit intermediate internal representation of retrieved information makes it difficult to reason about information sources, to log and analyze system behavior, and to refine answer generation logic. Existing systems also lack a clear mechanism to iteratively update dialog context and emotion-based tone control across multiple turns, which can lead to incoherent multi-turn dialogs and suboptimal user experience.

Additionally, traditional architectures often fail to tightly integrate natural language processing algorithms, structured data retrieval through a query language, and prompt engineering for a generative artificial intelligence model in a way that systematically improves accuracy and consistency. The server typically does not translate the user's natural language inquiry into a structured intent and target entity representation that can reliably drive selection of information sets in an information storage device. Consequently, the system cannot guarantee that the generative artificial intelligence model bases its responses on the correct, up-to-date internal data records.

Moreover, known systems usually do not incorporate emotion analysis of user input into the construction of prompts for the generative artificial intelligence model. Without such emotion-aware prompt control, the system cannot dynamically adjust tone, politeness level, or explanation depth based on user sentiment, leading to responses that may be perceived as inappropriate or unhelpful, especially in failure or troubleshooting scenarios. There is therefore a need for a technical solution that improves the way a server processes a user's inquiry, retrieves and structures internal information, constructs a prompt sentence for a generative artificial intelligence model, and controls multi-turn dialog and tone based on emotion analysis, in order to enhance the overall performance, reliability, and usability of the computer-based dialog system.

The specific processing by the specific processing unit 290 of the data processing device 12 in Example 1 is realized by the following means.

The present invention provides a server comprising a processor configured to receive, via a communication network, an inquiry input by a user through a terminal; preprocess the received inquiry using a natural language processing algorithm by segmenting the inquiry, converting the inquiry into a code sequence, and generating an analysis result indicating at least an estimated intent and a target entity; select, based on the analysis result, at least one information set stored in an information storage device by using a search condition associated with the intent and the target entity, and acquire related information by executing a query expressed in a structured query language; summarize the acquired related information, extract information elements to be included in an answer, structure the information elements as an internal representation, and generate a prompt sentence that includes the internal representation and the inquiry and that instructs a generative artificial intelligence model with respect to an answer generation method and an expression manner; input the generated prompt sentence to the generative artificial intelligence model, cause the generative artificial intelligence model to generate an answer candidate in a natural language form based on the prompt sentence, and select or format, from the answer candidate, an answer that satisfies a predetermined condition; transmit the selected or formatted answer to the terminal via the communication network so that the terminal displays the answer in a dialog-type interface; repeatedly receive additional input from the user regarding the inquiry and the answer, and, for each repetition, update at least the analysis result, the related information, the prompt sentence, and the answer so as to control a continuous dialog; and analyze expressions included in the inquiry and in the additional input using an emotion analysis algorithm, change at least one of a tone instruction and an explanation-amount instruction included in the prompt sentence according to an analyzed emotion, and thereby adjust the expression manner and a detail level of the answer generated by the generative artificial intelligence model. This enables the server to technically improve dialog processing by tightly integrating natural language understanding, structured data retrieval, and prompt-based control of a generative artificial intelligence model, thereby generating answers that are grounded in authoritative internal data, efficiently adapted across multi-turn interactions, and dynamically tailored in tone and detail to user emotion, while reducing unnecessary computational overhead and improving response consistency and reliability.

The term “system” refers to an arrangement of one or more computing devices and associated software components that cooperate to execute the functions described herein.

The term “server” refers to an electronic apparatus including at least one processor, a memory, and a communication interface, configured to provide processing and data services to one or more terminals over a communication network.

The term “processor” refers to a hardware computation unit, such as a central processing unit or a graphics processing unit, or a combination thereof, capable of executing instructions stored in a memory to perform the described operations.

The term “terminal” refers to a user-operated electronic device, such as a personal computer, a smart device, or a communication apparatus, configured to transmit inquiries to the server and receive and display answers from the server.

The term “communication network” refers to a wired or wireless data communication infrastructure, such as a local area network, a wide area network, or a public network, that enables data exchange between the server and the terminal.

The term “inquiry” refers to natural language text or equivalent user input expressing a request for information, assistance, or explanation, which is transmitted from the terminal to the server.

The term “natural language processing algorithm” refers to a software-implemented procedure, including but not limited to tokenization, embedding, classification, and sequence modeling, that analyzes and transforms human language input into a machine-interpretable form.

The term “code sequence” refers to a sequence of symbols, such as tokens or token identifiers, derived from an inquiry by the natural language processing algorithm and suitable for further computational processing.

The term “analysis result” refers to structured data generated by the natural language processing algorithm, indicating at least an estimated intent of the inquiry and one or more target entities related to the inquiry.

The term “intent” refers to a classification or label that represents a purpose or goal underlying an inquiry, such as requesting a release date, technical details, or troubleshooting information.

The term “target entity” refers to an object or concept identified within an inquiry, such as a product, service, feature, or error code, about which the user seeks information.

The term “information storage device” refers to a data storage subsystem, such as a database system or a file storage system, that stores one or more information sets accessible by the server.

The term “information set” refers to a logical collection of related data records, such as product information, technical documentation, or troubleshooting procedures, stored in the information storage device.

The term “search condition” refers to a set of parameters or constraints, derived from the intent and target entity, used to specify which information set and which records within the information storage device should be retrieved.

The term “structured query language” refers to a declarative query language used for managing and retrieving structured data in a database system.

The term “related information” refers to one or more data items retrieved from the information storage device that are determined to be relevant to the intent and target entity of the inquiry.

The term “summarize” refers to the operation of condensing the related information into a shorter representation that preserves information elements useful for generating an answer.

The term “information element” refers to a unit of information, such as a value, attribute, or statement, that is extracted from the related information for potential inclusion in an answer.

The term “internal representation” refers to a structured form, such as a data structure or object, in which the extracted information elements are organized for use in constructing a prompt sentence.

The term “prompt sentence” refers to text or an equivalent instruction structure provided as input to a generative artificial intelligence model, including at least the inquiry and the internal representation, and specifying how the answer should be generated.

The term “generative artificial intelligence model” refers to a machine learning model that, given a prompt sentence, probabilistically generates natural language output, such as an answer candidate.

The term “answer candidate” refers to natural language text produced by the generative artificial intelligence model based on a prompt sentence, before any selection or formatting is performed by the server.

The term “predetermined condition” refers to one or more selection criteria, such as completeness, length constraints, or inclusion of particular information elements, used to evaluate and choose among answer candidates.

The term “answer” refers to natural language text selected or formatted by the server from one or more answer candidates, and transmitted to the terminal as a response to the inquiry.

The term “dialog-type interface” refers to a user interface presentation on the terminal that displays exchanges between the user and the server in a conversational format, such as sequential messages.

The term “additional input” refers to user-provided information, such as follow-up questions, clarifications, or corrections, that is submitted after an initial answer in the course of a continuous dialog.

The term “continuous dialog” refers to a sequence of related exchanges between the user and the server, in which successive inquiries and answers are processed with reference to prior context.

The term “emotion analysis algorithm” refers to a computational procedure that analyzes linguistic expressions in user input to estimate an emotional state or sentiment, such as frustration, satisfaction, or urgency.

The term “tone instruction” refers to a directive included in the prompt sentence that specifies a style or manner of expression for an answer, such as politeness level, formality, or empathy.

The term “explanation-amount instruction” refers to a directive included in the prompt sentence that specifies a level of detail or length for an answer, such as brief, standard, or detailed explanation.

The term “expression manner” refers to stylistic characteristics of an answer, including tone, politeness, formality, and structure, as controlled or influenced by the prompt sentence.

The term “detail level” refers to a degree of informational depth or granularity in an answer, such as the amount of technical detail or number of included information elements.

In one embodiment, a server cooperates with one or more terminals operated by users to implement the claimed system. The server includes at least one processor, a main memory, a non-volatile storage device, and a network interface. The server executes an operating system such as a general-purpose server operating system and runs application software that implements natural language processing, structured data retrieval, prompt sentence generation, and interaction with a generative AI model. The terminal includes a processor, a display, an input interface such as a keyboard or a touch panel, and a communication module that communicates with the server over a wired or wireless communication network such as the Internet.

The terminal presents a dialog-type user interface that allows the user to enter an inquiry. The terminal runs a web browser or a native application framework such as a mobile application framework, and renders an input field and a message display area. The user inputs a natural language inquiry, for example, “Please tell me the release date of the new product.” or “Please tell me the technical details about Product Y.” or “Please explain the troubleshooting steps for error code E123.” The terminal captures the inquiry as a character string and transmits the string to the server through the communication network using a transport protocol such as HTTPS.

The server stores the received inquiry in the main memory and optionally in the non-volatile storage device as part of a dialog record. The server represents each inquiry as an object that includes fields such as a user identifier, a timestamp, a raw text field, and a dialog context identifier. The server thereby maintains a data structure that links multiple inquiries and answers within a continuous dialog. The server, by using such explicit data structures, can reuse context without rescanning entire logs, which reduces memory access overhead and improves response latency compared to conventional flat log storage.

The server applies a natural language processing algorithm to the inquiry. In one embodiment, the server uses a transformer-based language representation model such as a bidirectional encoder model as an intent classifier and an entity recognizer. The server implements the model using a machine learning framework such as a tensor-based numerical computation library. The server tokenizes the inquiry by applying a subword tokenizer associated with the model, maps each token to an integer identifier using a vocabulary table stored in memory, and constructs a tensor representation of shape (sequence length, embedding dimension). The server feeds this tensor into the transformer encoder layers, each layer performing multi-head self-attention, linear projection, residual connection, and layer normalization.

The server uses the output vector corresponding to a classification token to compute an intent distribution using a fully connected layer followed by a softmax function. The server interprets the highest-probability label as the estimated intent, such as an intent class representing a release-date request, a technical-detail request, or a troubleshooting request.

The server also applies a token-level classification head to the encoder outputs to detect target entities, such as product names or error codes, by predicting a label for each token and grouping contiguous tokens with entity labels. This structured analysis result, consisting of an intent label and a set of entities, is stored in memory as an analysis object.

The server uses the analysis object to determine which information set in an information storage device should be referenced. The information storage device may be implemented by a relational database management system executed by a separate database server or by the same server. The server associates each intent type with one or more database schemas and one or more query templates. For example, the server maps a release-date request intent to a product information schema, and maps a troubleshooting request intent to a support knowledge base schema. The server builds a structured query language statement by inserting entity values such as product names or error codes into parameterized query templates. The server uses a database driver library to open a connection to the database engine and execute the query.

The server receives a result set composed of rows that match the search condition. The server converts the result set into an intermediate in-memory representation that may include a list of record objects. Each record object contains fields such as a product identifier, a release date, a title, a technical specification field, or a troubleshooting step description. The server then performs summarization and selection over these record objects. In one embodiment, the server applies heuristic rules and vector-based similarity scoring to select the most relevant fields. The server, for example, calculates a term-frequency-based score or a cosine similarity score between an embedding of the inquiry and embeddings of record texts, and selects records with scores over a threshold. This selection procedure reduces the volume of text that must be processed by the generative AI model and thereby reduces both computation time and token-based billing cost, while improving the quality of the prompt content.

The server structures the selected information elements into an internal representation. The server may use a key-value map or a tree-like structure in memory where keys correspond to semantic roles such as “product_name,” “release_date,” “feature_list,” or “troubleshooting_steps,” and values are normalized text segments. By normalizing and structuring the data before answer generation, the server isolates raw storage formats from the generative AI input and can enforce consistency in the generated answers across different database schemas. This internal representation is an explicit intermediate artifact that is not present in conventional direct-prompt systems and contributes to improved reproducibility and debuggability of the dialog processing pipeline.

The server generates a prompt sentence for the generative AI model by combining the original inquiry text, the internal representation, and a set of control instructions. The server composes the prompt sentence according to a template that depends on the estimated intent.

For example, when the user inquires about a product release date, the server generates a prompt sentence such as:

“The user asked: ‘Please tell me the release date of the new product.’

Internal data: product name=New Product X; release date=2023-11-15.

Please answer in English in one concise sentence that clearly states the product name and the release date.”

When the user inquires about technical details, the server generates a prompt sentence such as:

“The user asked: ‘Please tell me the technical details about Product Y.’

Internal data: Product Y supports protocol Z, operates at 5V, and includes features A, B, and C.

Please generate a clear and user-friendly explanation in English suitable for a non-expert.”

When the user requests troubleshooting steps, the server generates a prompt sentence such as:

“The user asked: ‘Please explain the troubleshooting steps for error code E123.’

Internal data: error code E123 is resolved by steps S1, S2, and S3.

Please describe the steps in order, using numbered bullet points and simple language.”

The server stores the prompt sentence in memory and ensures that the prompt sentence length remains below a maximum token threshold defined by the generative AI model configuration. The server may remove redundant phrases, limit the number of records included in the internal data, and compress descriptions into succinct bullet points. This pre-processing reduces the length of the model input and thereby reduces computational load on the generative AI model, which translates into reduced inference time and energy consumption on the hardware executing the model.

The server interacts with a generative AI model that may be executed by an external inference server or locally. In one implementation, the generative AI model is a transformer-based autoregressive language model with multiple layers of self-attention and feed-forward networks. The model contains learned parameters including token embedding matrices, positional encodings, attention projection matrices, and layer-normalization parameters. The server loads model parameters from storage into memory and initializes model structures using a machine learning framework. During inference, the server feeds the prompt sentence, tokenized as a sequence of token identifiers, into the model. The model iteratively computes attention weights among tokens, applies linear projections and non-linear activation functions, and generates a probability distribution for the next token at each time step.

The server controls generation by specifying model parameters such as maximum output length, temperature, and top-k or top-p sampling thresholds. By appropriately tuning these parameters for each intent type, the server achieves consistent style and factual coherence while suppressing low-probability hallucinations. For example, the server uses a lower temperature setting and a narrow top-k range for critical factual responses such as release dates and error codes, and uses a slightly higher diversity setting for technical explanations where richer wording is acceptable.

The server may train or fine-tune the generative AI model using a training dataset that includes pairs of internal representations, inquiries, and desired answers. The server uses a loss function such as cross-entropy between the predicted token distributions and the correct next-token labels, and updates model weights via gradient descent methods such as Adam.

The server may employ regularization techniques such as dropout and weight decay to prevent overfitting. The server may also use data augmentation by paraphrasing inquiries, varying answer styles, and including different combinations of internal data fields to increase model robustness.

The server receives an answer candidate from the generative AI model as a sequence of tokens, converts the tokens back into natural language text using the model's vocabulary, and stores the text in memory. The server may apply post-processing filters to enforce business or safety policies, but in a technical sense, the server also evaluates the answer candidate against predetermined conditions such as required keyword presence, maximum length, and consistency with the internal representation. The server can compute similarity scores between the answer text and the internal representation to detect whether required data items, such as a specific date or error code, appear in the output. If an answer candidate fails the conditions, the server may regenerate the answer using a modified prompt sentence that places stronger emphasis on missing elements, or may fall back to a template-based answer that directly inserts database values into a fixed sentence pattern. This multi-path control flow allows the server to guarantee a minimum level of factual correctness while still benefiting from the flexibility of the generative AI model.

The server transmits the selected or formatted answer to the terminal. The terminal receives the answer text and displays it in the dialog-type interface. The terminal shows both the user's inquiries and the server's answers in a chronological order, optionally with timestamps and status indicators. The user can then input additional inquiries or clarifications, for example, “Please tell me more details about the troubleshooting procedure” or “Please compare this new product with the previous model.” The terminal forwards each additional input to the server.

The server maintains, for each dialog, a context object that stores prior inquiries, answers, analysis results, and internal representations. The server, upon receiving additional input, incorporates the context object to refine the analysis. For example, the server may merge entities from previous turns, such as treating “this product” as the same product mentioned earlier. The server may use a context encoder or a memory mechanism that processes multiple turns, computing attention not only over the current inquiry tokens but also over embeddings of prior utterances. This mechanism allows the server to resolve references and maintain coherent multi-turn dialogs, which reduces the need for redundant clarification questions and thus improves overall interaction efficiency.

The server performs emotion analysis on user input by applying a separate neural classification model or a rule-based sentiment scoring algorithm. In one embodiment, the server uses a transformer-based classifier trained on labeled sentiment data, where each input sequence is associated with labels such as “frustrated,” “neutral,” or “satisfied.” The server obtains an embedding from the classification token and computes probabilities over emotion classes. The server maps these probabilities to control variables such as tone level and explanation depth. For example, when the emotion classifier outputs a high probability for frustration, the server sets tone level to “more polite and empathetic” and explanation depth to “more detailed.” The server then embeds textual instructions such as “Use a polite and empathetic tone” or “Provide a more detailed step-by-step explanation” into the prompt sentence. By directly embedding such control tokens or phrases into the prompt, the server uses the generative AI model's conditional generation capability to adjust style and length of the answer. This emotion-aware prompt modification is a non-trivial technical integration that changes the internal representation of the input sequence and improves user-perceived quality without requiring separate static templates for each emotion state.

The server achieves technical improvements over conventional systems in several ways.

First, the server reduces model input size by performing intent-based selection and summarization of database records, which leads to faster inference and lower memory bandwidth usage in the generative AI model. Second, by structuring retrieved data into an internal representation and embedding that representation into a prompt sentence, the server constrains the generative AI model to operate on curated factual content, which improves answer accuracy and reduces the probability of hallucinated content. Third, by explicitly modeling dialog context and emotion state as structured data and feeding them as control signals to the model, the server enables non-trivial dynamic adaptation of output style and detail level, which is difficult to accomplish with fixed templates or naive prompting. Fourth, the server's modular architecture, where natural language parsing, database querying, prompt generation, and answer verification are distinct yet interacting components, allows parallel optimization and scaling across multiple processors or machines, reducing response latency under high load.

The server, in alternative embodiments, may use different natural language processing algorithms. For example, the server may employ a recurrent neural network-based intent classifier, a convolutional neural network-based text feature extractor, or a hybrid model combining rule-based entity extraction with neural intent detection. The server may also replace a relational database with a document store or a knowledge graph. In the knowledge graph configuration, the server maps entities to nodes and relations to edges, and performs graph traversal based on the intent. The server then encodes retrieved graph nodes into a structured internal representation that is again supplied to the generative AI model via the prompt sentence.

The terminal, in other embodiments, may be integrated into specialized equipment such as a maintenance console for industrial machinery or a control panel for network devices. In such cases, the server may not only provide textual answers but also transmit control instructions derived from the internal representation and the generative AI output. For example, when the user asks for troubleshooting steps for a specific error code, the server may, in addition to describing steps, instruct the terminal to highlight corresponding control buttons or to automatically open configuration screens. This linkage between dialog content and device control demonstrates that the invention is not limited to abstract information processing but extends to controlling physical or virtual devices through the terminal interface.

The server, across these embodiments, consistently uses the combination of natural language processing, structured query of internal information sets, explicit internal representation, and emotion-aware prompt sentence generation to improve the computer's ability to process user inquiries. The server thereby provides a concrete technical solution that enhances computational efficiency, accuracy, and controllability of a dialog system that uses a generative AI model, going beyond mere automation of human decision-making and providing improvements in the operation of the computer system itself.

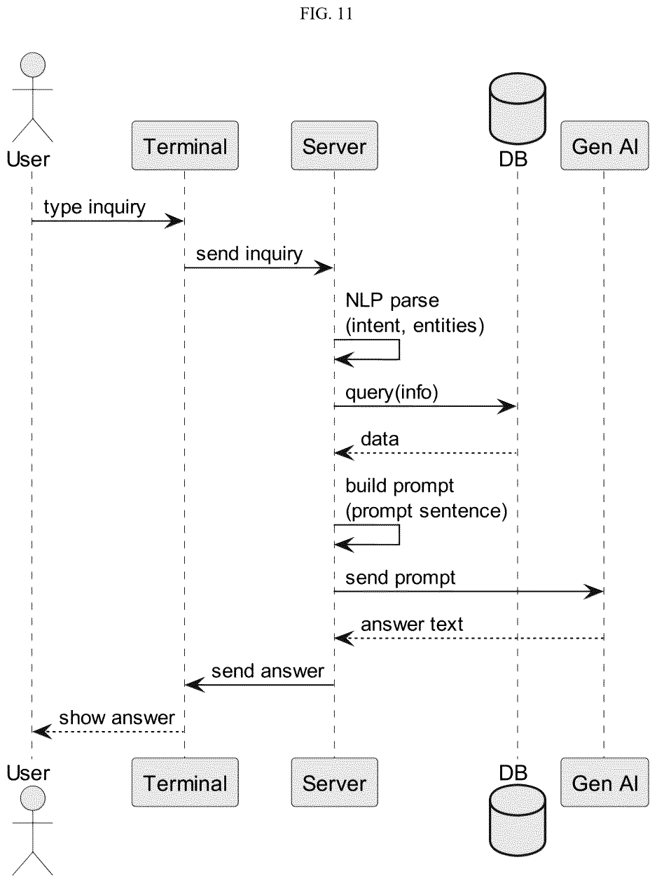

The following describes the processing flow using FIG. 11.

### Step 1:

User operates the terminal and inputs a natural language inquiry into a text input field, such as “Please tell me the release date of the new product.” or “Please explain the troubleshooting steps for error code E123.”

Terminal receives, as input, the sequence of characters typed by the user and converts the characters into a Unicode string object. Terminal then constructs a request payload that includes the inquiry string, a user identifier, and a dialog identifier, and transmits this payload to the server over a communication network using a protocol such as HTTPS.

Terminal outputs, to the server, a message containing the raw inquiry text and associated metadata.

### Step 2:

Server receives, as input, the HTTPS request from the terminal containing the inquiry text and metadata. Server parses HTTP headers and a request body using a network library and stores the parsed information in memory as a request object.

Server performs validation on the inquiry text by checking length constraints, allowed character sets, and presence of required fields such as user identifier and dialog identifier.

Based on this validation, server either accepts the inquiry for further processing or returns an error response.

Server outputs a validated inquiry string and associated metadata for subsequent natural language processing.

### Step 3:

Server receives, as input, the validated inquiry string and metadata. Server applies a text normalization routine, including operations such as trimming whitespace, normalizing Unicode, and optionally converting characters to a consistent case.

Server tokenizes the normalized inquiry using a tokenizer associated with a transformer-based natural language processing model. Server maps the tokens to integer token identifiers via a vocabulary table and constructs an embedding index sequence.

Server outputs, to a natural language processing module, a token identifier sequence representing the inquiry and the original text for reference.

### Step 4:

Server receives, as input, the token identifier sequence and feeds the sequence into an encoder model for intent classification and entity recognition. Server, using a transformer encoder, computes contextualized embeddings by applying multi-head self-attention, linear transformations, and non-linear activation functions layer by layer.

Server applies a classification head to the embedding of a special classification token to compute an intent probability distribution, then selects the highest-probability intent label as the estimated intent. Server also applies a token-level classification head to each token embedding to assign entity labels and groups contiguous tokens with entity labels to form entity spans such as product names or error codes.

Server outputs an analysis result that includes at least one intent label and a list of target entities with their text spans and types.

### Step 5:

Server receives, as input, the analysis result containing the intent and target entities. Server uses a mapping table or rule set that associates each intent label with one or more database schemas and query templates.

Server constructs a structured query language statement by inserting the extracted entity values into placeholders of a parameterized query template. For example, for a release-date intent, server inserts the product name into a WHERE clause of a product table query.

Server outputs a completed structured query language statement and a reference to the target information set to be queried.

### Step 6:

Server receives, as input, the structured query language statement and a reference to the target information set. Server opens or retrieves a database connection from a connection pool managed for a relational database management system.

Server sends the structured query language statement to the database engine, which executes it against stored tables containing product information, technical documentation, or troubleshooting procedures. Server retrieves the resulting rows from the database engine and converts each row into an in-memory record object with fields such as identifiers, titles, dates, and descriptions.

Server outputs a collection of record objects representing the related information retrieved from the information storage device.

### Step 7:

Server receives, as input, the collection of record objects and the original inquiry. Server computes relevance scores for each record by applying heuristic rules and numerical similarity functions, such as cosine similarity between vector embeddings of the inquiry text and of the record descriptions.

Server filters out records with scores below a threshold and ranks remaining records according to descending relevance. Server then extracts specific fields, such as release dates, feature lists, or troubleshooting steps, from the highest-ranked records.

Server outputs a reduced set of information elements that have been selected as most relevant to the user's intent and target entities.

### Step 8:

Server receives, as input, the reduced set of information elements. Server structures these elements into an internal representation, such as a key-value map where keys correspond to semantic roles (for example, “product_name,” “release_date,” “feature_list,” “troubleshooting_steps”) and values are normalized text segments.

Server may further compress or normalize texts by removing redundant phrases, splitting long descriptions into bullet-like segments, and ensuring consistent formatting of dates, names, and codes. These operations reduce length and unify format.

Server outputs the internal representation as a structured data object that is ready to be embedded into a prompt sentence.

### Step 9:

Server receives, as input, the internal representation, the original inquiry, and dialog metadata including prior turns. Server optionally retrieves previous inquiries and answers from a dialog context store and determines whether the current inquiry references prior entities or topics.

Server composes a prompt sentence by inserting the original inquiry, the internal representation, and explicit instructions into a template specific to the detected intent. Server, for example, adds directives such as “Please answer in English in one concise sentence” or “Please generate a detailed step-by-step explanation.”

Server outputs a complete prompt sentence that encodes both factual data and generation instructions for the generative AI model.

### Step 10:

Server receives, as input, the current user input and any prior user inputs in the same dialog.

Server passes these texts through an emotion analysis algorithm, such as a sentiment classification model, to estimate emotion categories or scores including frustration, urgency, or satisfaction.

Server maps the estimated emotion to control variables such as tone level and explanation depth. Server then modifies the prompt sentence by adding or updating phrases that instruct the generative AI model about tone and detail, for example, “Use a polite and empathetic tone” or “Provide a more detailed explanation.”

Server outputs an emotion-adjusted prompt sentence that includes both factual internal representation and dynamically selected tone and detail instructions.

### Step 11:

Server receives, as input, the emotion-adjusted prompt sentence. Server tokenizes the prompt sentence using the tokenizer associated with the generative AI model, maps the tokens to identifiers, and constructs an input sequence for the model.

Server forwards this input sequence to a generative AI model, which is an autoregressive transformer model configured with a specified number of layers, attention heads, and embedding dimensions. Server sets generation parameters including maximum output length, temperature, and sampling thresholds. The model computes, for each new token, a probability distribution based on prior tokens and network weights, and the server samples or selects tokens according to the configured parameters until an end condition is met.

Server outputs an answer candidate as a sequence of tokens converted back into a natural language text string.

### Step 12:

Server receives, as input, the answer candidate text and the internal representation. Server evaluates the answer candidate against predetermined conditions, such as presence of required key values (for example, specific dates or error codes), adherence to a maximum character length, and the absence of disallowed patterns.

Server may compute a similarity score between the answer candidate and the internal representation to verify that all critical information elements appear in the text. If the answer candidate fails the conditions, server either triggers regeneration with an adjusted prompt or constructs a fallback answer by directly inserting database values into a fixed template.

Server outputs a validated and, if necessary, reformatted answer text that satisfies the predetermined conditions.

### Step 13:

Server receives, as input, the validated answer text. Server packages the answer into a response message that also includes metadata such as timestamps and dialog identifiers.

Server serializes this message into a format compatible with the terminal and sends it back over the communication network using HTTPS.

Server updates the dialog context store by appending the inquiry, internal representation, prompt sentence, and final answer, thereby enabling context-aware processing for subsequent turns.

Server outputs the response message to the terminal and an updated dialog context maintained in server-side storage.

### Step 14:

Terminal receives, as input, the response message from the server. Terminal parses the message, extracts the answer text, and appends it to the dialog-type user interface as a new system message.

Terminal updates the display so that the user can view the latest answer in chronological order alongside previous inquiries and answers. Terminal keeps the input field active so that the user can submit additional inquiries or clarifications in the same dialog.

Terminal outputs the rendered answer on the display and a ready state for further user input.

### Step 15:

User receives, as input, the displayed answer on the terminal screen. User reviews the content to determine whether the information is sufficient, clear, and responsive.

User, based on this evaluation, may generate additional input such as “Please tell me more details about the troubleshooting procedure” or “Please compare this new product with the previous model.” User then enters this new inquiry into the terminal, which restarts the processing from an earlier step with the updated dialog context.

User outputs a new natural language inquiry that becomes input for the next iteration of the processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented customer support systems that utilize machine learning or generative artificial intelligence models suffer from several technical deficiencies at the system and algorithm levels. First, typical architectures directly pass a user's natural language inquiry to a generative model and then return the model's output to a terminal device with minimal intermediate processing. This often results in responses that are inconsistent with underlying enterprise data, include content that is not present in the internal information storage, or vary unpredictably in tone and style. Such behavior reflects a lack of explicit control over how the generative model consumes structured information and constraints, and leads to a technically unreliable human-machine interface.

Second, in many existing systems, the interaction between the application server, the internal information storages, and the generative artificial intelligence model is not designed as a structured, sequential processing pipeline. The server typically does not generate a machine-controlled prompt sentence that explicitly encodes search results, usage constraints, and response policies for the generative model. As a result, the generative model performs text generation in a largely unconstrained manner, which degrades the accuracy, reproducibility, and debuggability of the overall computing process.

Third, conventional systems usually treat user emotion and dialogue context at the application layer, if at all, without integrating them into the low-level prompt generation logic executed by the processor. Consequently, the server does not adapt the expression style or response tone in a systematic, processor-controlled way. This leads to a rigid and inconsistent dialogue experience that fails to leverage available emotional or contextual signals to optimize the behavior of the generative model.

Fourth, typical implementations do not log and reuse detailed processing histories for improving prompt generation logic or search conditions. Without maintaining processing logs that link each inquiry, each prompt sentence, each search query, and each generated answer, the system cannot systematically refine its internal algorithms. This limits the ability of the server to self-optimize its information retrieval and prompt construction mechanisms over time, and thereby constrains the technical performance of the dialogue system.

Accordingly, there is a need for a computer-implemented system and method that (i) converts a natural language inquiry into structured data representing user intent, (ii) retrieves only relevant information from one or more information storages, (iii) generates a constrained prompt sentence that explicitly instructs a generative artificial intelligence model to use only the retrieved information, (iv) verifies consistency between the retrieved information and the generated answer and, if necessary, regenerates and resubmits the prompt sentence, and (v) adjusts the expression style and response tone based on user emotion and dialogue history, while maintaining processing logs to refine prompt generation and search conditions. By addressing these issues, the invention aims to improve the technical functioning of the server and the reliability, controllability, and efficiency of computer-based dialogue processing using a generative artificial intelligence model.

The specific processing by the specific processing unit 290 of the data processing device 12 in Application Example 1 is realized by the following means.

The present invention provides a server comprising a processor configured to receive, via a communication interface, a natural language inquiry sentence and associated identification information from a terminal device; to perform morphological analysis and context analysis on the inquiry sentence using a natural language processing technique to generate structured data including an inquiry intention and target information; to generate a search query for at least one information storage based on the structured data and to acquire, from an information collection stored in the information storage, information related to the inquiry sentence; to generate a prompt sentence including the inquiry sentence, the structured data, and the acquired information, the prompt sentence explicitly instructing a generative artificial intelligence model regarding conditions and constraints for answer generation and instructing the generative artificial intelligence model to use only the acquired information; to transmit the prompt sentence to an external generative artificial intelligence model providing apparatus and to receive, from the generative artificial intelligence model providing apparatus, an answer sentence generated based on the prompt sentence; to examine consistency between contents of the acquired information and the answer sentence, and when inconsistency or inclusion of content not present in the information collection is detected, to regenerate the prompt sentence so as to exclude such content and retransmit the regenerated prompt sentence to the generative artificial intelligence model to correct the answer sentence; to transmit a corrected answer sentence as response information to the terminal device, and to store a dialogue history including the response information; to adjust an expression style and a response tone in the prompt sentence based on information related to user emotion transmitted from the terminal device or based on an emotion analysis result with respect to the inquiry sentence and the dialogue history; and to store a processing log representing sequential execution of inquiry reception, natural language analysis, information searching, prompt sentence generation, answer sentence generation, consistency examination, and answer transmission, and to update a prompt generation logic and a search condition for the information collection based on the processing log. This enables improved control over interaction between the server and the generative artificial intelligence model, thereby increasing consistency between generated answers and internal information storages, enhancing adaptability of response style to user emotion and dialogue context, and improving the overall technical reliability, transparency, and efficiency of computer-implemented dialogue processing.

The term “system” refers to a combination of one or more hardware devices and one or more software programs that cooperate to perform information processing, communication, and control operations as described in the claims.

The term “processor” refers to a hardware arithmetic and logic unit, central processing unit, or processing circuitry that executes instructions of a software program to perform the specified functions.

The term “communication device” refers to a hardware interface or communication module that enables wired or wireless data transmission between the processor and an external device or network.

The term “terminal device” refers to an end-user computing apparatus, such as a mobile device, a personal computer, or another client device, that transmits an inquiry and receives a response via a network.

The term “natural language inquiry sentence” refers to a text string expressed in a human language and input by a user to request information or assistance from the system.

The term “identification information” refers to data that uniquely or semi-uniquely associates an inquiry sentence with a user, an object, or a context, such as a user identifier, product identifier, or order identifier.

The term “natural language processing technique” refers to a software-implemented method for analyzing and interpreting human language text, including at least one of tokenization, morphological analysis, syntactic analysis, semantic analysis, or context analysis.

The term “morphological analysis” refers to a process of segmenting a natural language sentence into word units or morphemes and determining grammatical attributes or parts of speech for the respective units.

The term “context analysis” refers to a process of determining semantic relationships, discourse structure, or pragmatic meaning of words and phrases in an inquiry sentence, taking into account their surrounding text and dialogue history.

The term “structured data” refers to data represented in a predefined format, such as a record or a key-value set, that explicitly includes at least an inquiry intention and target information derived from a natural language inquiry sentence.

The term “inquiry intention” refers to a representation of a user's purpose or requested operation extracted from an inquiry sentence, such as a request for a product attribute, a delivery time, or a usage condition.

The term “target information” refers to an object, attribute, or data category that is the subject of the inquiry intention, such as a specific item, parameter, or attribute in an information storage.

The term “information storage” refers to a logical or physical data repository, such as a database or file storage, that stores an information collection accessible by the processor.

The term “information collection” refers to one or more sets of data records, documents, or structured entries stored in an information storage and usable for generating an answer to an inquiry.

The term “search query” refers to a data structure or command, such as a database query or retrieval request, generated by the processor to access and retrieve relevant information from an information storage.

The term “prompt sentence” refers to a text sequence or message generated by the processor and provided as input to a generative artificial intelligence model, the text sequence including instructions, conditions, constraints, and information to be used for answer generation.

The term “generative artificial intelligence model” refers to a machine-learned model configured to generate natural language text or other content in response to an input prompt sentence, using parameters obtained through training on data.

The term “generative artificial intelligence model providing apparatus” refers to a computing apparatus or service that hosts and executes a generative artificial intelligence model and returns generated content in response to a prompt sentence.

The term “answer sentence” refers to a natural language text output generated by the generative artificial intelligence model based on a prompt sentence and intended to respond to a user inquiry.

The term “consistency” refers to a logical and factual correspondence between contents of acquired information from an information collection and the contents of an answer sentence generated by the generative artificial intelligence model.

The term “dialogue history” refers to stored information representing a sequence of interactions between the system and a user, including at least inquiry sentences, prompt sentences, and answer sentences.

The term “response information” refers to data transmitted from the processor to the terminal device that includes at least a corrected answer sentence and optionally associated metadata.

The term “expression style” refers to linguistic characteristics of an answer sentence or prompt sentence, including formality, politeness, sentence structure, and vocabulary selection.

The term “response tone” refers to an emotional or attitudinal quality of an answer sentence, such as friendly, neutral, apologetic, or formal, controlled by the processor.

The term “user emotion” refers to an estimated or reported affective state of a user, such as satisfaction, frustration, or confusion, derived from explicit user input, behavioral signals, or emotion analysis.

The term “emotion analysis result” refers to data indicating a detected or inferred user emotion, produced by processing the inquiry sentence, dialogue history, or other user-related information.

The term “processing log” refers to stored data describing one or more steps executed by the processor for handling an inquiry, including timestamps, intermediate results, generated queries, prompt sentences, and answer sentences.

The term “prompt generation logic” refers to rules, algorithms, or parameterized procedures executed by the processor to construct a prompt sentence based on structured data, acquired information, dialogue history, and other context.

The term “search condition” refers to criteria, filters, or parameters used in a search query for an information storage, which determine which records or data are retrieved as related information.

In one embodiment, a server executes an information processing program on a hardware platform that includes at least a central processing unit, a main memory, a non-volatile storage device, and a network interface. The server uses an application framework, such as a web application framework implemented in a general-purpose programming language (for example, a framework comparable to Flask implemented in a language comparable to Python), to provide an application programming interface accessible from a terminal. The server further uses a natural language processing library (for example, a library comparable to spaCy or NLTK) and a database access library (for example, a library comparable to SQLAlchemy or a native database driver) to perform internal data processing and data operations. The server communicates with an external computing apparatus that provides a generative AI model implemented as a transformer-type neural network.

The terminal operates as a client device such as a smartphone, a tablet, or a personal computer. The terminal includes at least a processor, a memory, a display, a user input interface (for example, a touch panel or a keyboard), and a communication interface. The terminal executes a client application or a web browser and establishes an encrypted communication session with the server via a network. The terminal displays an input region for a natural language inquiry and transmits a user's inquiry sentence, together with associated identification information (such as a user identifier, a product identifier, or a transaction identifier), to the server.

The user observes application content on the display of the terminal, inputs a natural language inquiry sentence, and confirms transmission. The user interacts with the system through iterative inquiries and responses, but the user does not need to understand internal data structures or processing flows executed by the server.

The server stores an information collection in one or more information storages. In one embodiment, the server uses a relational database management system such as a database comparable to PostgreSQL or a database comparable to MySQL to store structured records of product information, technical specifications, logistics information, and support rules. Each record includes fields such as a primary key, category codes, attribute names, attribute values, timestamps, and version identifiers. In another embodiment, the server uses a document-oriented database such as a database comparable to MongoDB to store semi-structured documents including frequently asked questions and support guidelines. The server maintains index structures, such as B-tree indexes and inverted indexes, to accelerate retrieval of the information collection.

The server executes a natural language processing module that converts a received natural language inquiry sentence into structured data. In one embodiment, the server performs tokenization, part-of-speech tagging, lemmatization, and dependency parsing using a statistical or neural sequence labeling model included in the natural language processing library. The server maps tokens and syntactic structures to an intent label and one or more slot values using a classifier, such as a feed-forward neural network or a recurrent neural network trained on annotated inquiry-intent pairs. The structured data includes at least an inquiry intention label, a target information type, and a reference to identification information received from the terminal.

The server uses the structured data to generate a search query for the information storage. For example, when the inquiry intention is a request for product material information, the server generates a relational query selecting material-related fields from a product table for a given product identifier. The server binds parameters using prepared statements or object-relational mapping so that the query structure is fixed and only parameter values vary. The server thus performs arithmetic and logical operations at the database engine level, such as comparisons, joins, and aggregations, in order to derive a minimal set of relevant attributes. This design reduces data transferred from the database to the application layer and decreases processing time in the server.

The server constructs a prompt sentence that is provided to the generative AI model. The prompt sentence incorporates the original inquiry sentence, the structured data, and the acquired information from the information collection, and it further includes explicit conditions and constraints. In one example, when the user inquires about a material of a product, the server generates a prompt sentence such as:

“Customer question: ‘What is the material of this product?’

Database information: product_name=Cotton Shirt; outer material=100% cotton; lining material=100% polyester.

You are a customer support assistant.

Using only the database information above, generate a concise English answer explaining the materials of this product.

Do not invent any additional materials.”

In another example, when the user inquires about delivery time, the server generates a prompt sentence such as:

“Customer question: ‘How long will it take for this item to be delivered?’

Database information: order A-98765 has shipped via standard delivery; estimated delivery date=5 February 2026.

You are a customer support assistant.

Using the database information above, generate a friendly and clear explanation in English of when the order is expected to arrive.

Do not mention any dates or information that are not present in the database information.”

The server transmits the prompt sentence to the external generative AI model providing apparatus. The generative AI model is implemented as a multi-layer transformer neural network having an encoder-decoder or decoder-only architecture with self-attention and feed-forward sublayers. The model stores learned parameters, including weight matrices for attention heads, layer normalization parameters, and token embedding matrices. The model receives tokenized representations of the prompt sentence, computes attention scores between tokens across multiple layers, and generates an answer sentence token by token.

During training, such a generative AI model is pre-trained on large-scale text corpora using an objective such as next-token prediction with a cross-entropy loss function. Model parameters are updated by gradient-based optimization, such as stochastic gradient descent with variants like Adam. Training data may be augmented by applying text normalization, synonym substitution, or segment reordering to increase robustness. Fine-tuning may be performed on domain-specific support dialogues so that the model better adheres to enterprise support patterns. By opening the model's design and training configuration, the system clarifies that the model internally optimizes parameters through numerical operations that are difficult to perform manually and that are not mere automation of human decision-making.

The server receives the answer sentence generated by the generative AI model and executes a consistency checking module. The server compares textual elements of the answer sentence against normalized values of the acquired information. In one embodiment, the server maps both the answer sentence and the acquired information to feature representations such as token sets, n-gram sets, or semantic embeddings, and then computes similarity scores or containment relationships. The server detects occurrences of terms in the answer sentence that are not present in the acquired information or that conflict with numerical or categorical constraints encoded in the information collection. If inconsistency is detected, the server regenerates a prompt sentence that more strongly constrains the generative AI model. An example of a regenerated prompt sentence is:

“Customer question: ‘What is the material of this product?’

Database information: product_name=Cotton Shirt; outer material=100% cotton; lining material=100% polyester.

You are a customer support assistant.

Using only the database information above, generate a concise English answer explaining the materials of this product.

If a material is not listed in the database information, explicitly state that the information is not available and do not mention any other materials.”

By iteratively tightening the constraints in the prompt sentence, the server reduces the chance that the generative AI model outputs information not grounded in the information collection.

This improves factual accuracy and reduces model hallucination. Because the server decides when and how to regenerate the prompt sentence based on deterministic rules and computed similarity measures, the system implements a non-conventional control loop around the generative AI model rather than invoking the model in an unconstrained way.

The server stores dialogue history for each user or session. The dialogue history includes past inquiry sentences, structured data, prompt sentences, acquired information snapshots, and answer sentences. The server uses the dialogue history to generate context-aware prompt sentences that reflect previous answers and unresolved questions. The server aggregates history into a compact representation, such as a sequence of truncated turns or a vector embedding summarizing prior content, to limit prompt length and reduce communication load with the external model. This compression and selection process improves communication efficiency and latency by avoiding transmission of unnecessary context.

The server further maintains processing logs that record internal operations including timestamps, selected information storages, search queries, prompt generation parameters, consistency checking outcomes, and model response metrics such as response length and latency. The server analyzes the processing logs periodically using offline or online learning methods. For example, the server may train a meta-model that predicts which prompt structures yield higher consistency rates and lower regeneration counts, and then adapt future prompt-generation rules accordingly. This log-driven adaptation results in gradual improvement of prompt generation logic and search conditions, leading to higher overall accuracy and reduced computational waste.

The server also analyzes user emotion either from explicit signals transmitted from the terminal (for example, selection of an emotion icon) or from the inquiry sentence and dialogue history using a separate classifier model. The classifier may be implemented as a neural network trained on labeled emotion data and may output labels such as “frustrated,” “satisfied,” or “confused” with associated probabilities. The server interprets the emotion label and adjusts expression style and response tone in subsequent prompt sentences. For example, when the classifier detects user frustration, the server may insert instructions such as:

“Use an apologetic and supportive tone.

Acknowledge any inconvenience and provide clear, step-by-step guidance.”

By embedding explicit tone instructions into the prompt sentence, the server enforces systematic control of output style at a technical level. This differs from manual selection of templates because the style control is integrated into the algorithmic prompt construction process and is conditioned on machine-detected emotion, which is a technical signal obtained by model-based classification.

The terminal receives the answer sentence included in the response information from the server. The terminal parses the response and updates the user interface. In one embodiment, the terminal draws dialog bubbles on the display and scrolls the viewport automatically so that the latest answer is visible. The terminal also caches the latest responses, enabling offline review and reducing repeated server queries. By offloading part of the presentation and caching functions to the terminal, the system reduces unnecessary communication between the server and the terminal.

This configuration yields several technical effects. First, by converting natural language inquiries into structured data and by constraining database queries and prompt generation based on that structure, the server reduces the size of data transmitted to and from the external generative AI model. This reduction leads to lower network latency and lower bandwidth usage, which are measurable improvements in communication performance.

Second, the consistency checking and prompt-regeneration loop ensures that the generative AI model outputs text that is aligned with database contents, thereby reducing the need for manual review and re-querying. This directly decreases computational cost and improves throughput because fewer redundant model invocations and database accesses are required over time.

Third, the log-based adaptive update of prompt generation logic and search conditions represents an improvement of computer operation. The server uses historical performance metrics to adjust algorithmic parameters for future processing, leading to optimized query plans and improved cache hit rates. Fourth, the emotion-aware tone control integrated at the prompt level enables a single generative AI model to handle multiple interaction styles without switching models or reloading templates. This reduces memory consumption and initialization overhead on the external model providing apparatus while preserving user-specific style adaptation.

In an alternative embodiment, the server uses multiple information storages for different data domains, such as a first storage for structured product attributes, a second storage for troubleshooting procedures, and a third storage for policy documents. The server selects which storage or combination of storages to query based on the inferred inquiry intention and target information type in the structured data. The server may issue parallel queries to multiple storages and then merge the acquired information into a unified representation before prompt construction. Such multi-storage selection, in combination with structured intent labeling, improves retrieval precision and reduces superfluous data transfer, thereby enhancing overall computational efficiency.

In another embodiment, the generative AI model is hosted locally on the same hardware platform as the server rather than on an external apparatus. In that case, the server allocates a dedicated accelerator, such as a graphics processing unit or a tensor processing unit, to execute matrix operations of the transformer architecture. The server manages model loading, parameter caching, and batching of multiple prompt sentences in a queue to increase hardware utilization. This configuration further improves processing speed and reduces dependence on external network connections.

In yet another embodiment, the server employs a rule-based pre-filtering stage that uses deterministic pattern matching to identify simple inquiries for which pre-authored responses are stored in the information collection. In such cases, the server may bypass the generative AI model and return a precomputed answer, thereby drastically reducing processing time and cost. The server records such bypass events in the processing log and uses them to adjust the classification threshold between model-based and rule-based handling, further optimizing system behavior.

Through these hardware and software arrangements, the server, the terminal, and the user cooperate to perform dialogue processing in a manner that is not limited to abstract mental steps or business rules. The server performs concrete numerical and logical operations on structured data, executes trained neural network models with specific architectures and loss functions, and uses algorithmic control over prompt sentences to enforce constraints on generative output. This combination of features improves the processing speed, accuracy, communication efficiency, and robustness of the overall system, thereby realizing a technical improvement in computer-based natural language interaction.

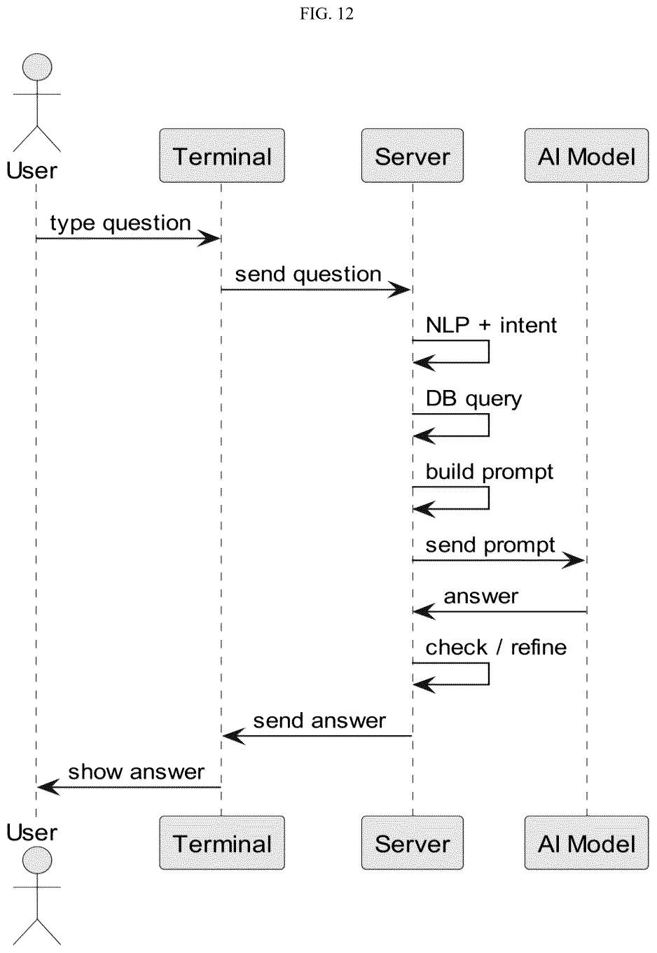

The following describes the processing flow using FIG. 12.

### Step 1:

Terminal displays an input interface and captures a user inquiry.

Terminal presents a text input field and optional selection widgets (for example, product selection or order selection) on a display.

Terminal receives, as input, a natural language inquiry sentence from the user and context data such as a product identifier or order identifier from an internal application state.

Terminal performs basic validation on the input, such as checking that the inquiry sentence is non-empty and that identifiers conform to expected formats.

Terminal generates an internal data structure that combines the inquiry sentence and the context data, and prepares this structure as a request payload to the server.

The output of Step 1 is a validated inquiry payload in the terminal memory, including at least the inquiry sentence and associated identification information.

### Step 2:

Terminal transmits the inquiry payload to the server.

Terminal opens or reuses a secure network connection, such as an HTTPS connection, to a predefined server endpoint.

Terminal encodes the inquiry payload into a structured message format, for example a serialized text-based format, and sends the message through the communication interface to the server.

Terminal waits for an acknowledgment from the server indicating that the payload has been received successfully.

The input of Step 2 is the validated inquiry payload generated in Step 1, and the output of Step 2 is the transmission of this payload to the server and the establishment of a communication context for the corresponding session.

### Step 3:

Server receives and parses the inquiry payload.

Server, via its network interface, accepts an incoming message from the terminal and stores the raw payload in a reception buffer.

Server parses the payload according to a predefined schema, extracting fields such as user identifier, inquiry sentence, product identifier, and order identifier.

Server validates the extracted fields by checking data types, required fields, and identifier formats, and discards or flags malformed messages.

Server logs meta-information such as reception time, terminal address, and request size for monitoring.

The input of Step 3 is the transmitted inquiry payload from the terminal, and the output of Step 3 is a validated internal representation of the inquiry stored in server memory.

### Step 4:

Server performs natural language preprocessing on the inquiry sentence.

Server passes the inquiry sentence to a natural language processing module that executes tokenization, part-of-speech tagging, and sentence boundary detection.

Server converts the text into a sequence of tokens, assigns grammatical tags to each token, and normalizes word forms (for example, converting plurals to singulars and verbs to base forms).

Server stores the resulting token sequence and associated tags in a structured data object for further analysis.

The input of Step 4 is the raw inquiry sentence extracted in Step 3, and the output of Step 4 is a tokenized and tagged representation of the inquiry sentence.

### Step 5:

Server infers an inquiry intention and target information from the processed text.

Server feeds feature representations derived from the tokenized text, such as word embeddings or n-gram counts, into an intent classification module.

Server applies a trained classification algorithm, such as a neural network or a support vector machine, to determine an inquiry intention label (for example, “ask_product_material,” “ask_delivery_time,” or “ask_return_policy”).

Server also identifies target entities or attributes by detecting named entities and slot values, such as a product attribute type or an order status field.

Server assembles these results into structured data that includes both the inferred intention and the target information elements.

The input of Step 5 is the tokenized and tagged representation from Step 4, and the output of Step 5 is structured data capturing the inquiry intention and target information.

### Step 6:

Server selects appropriate information storages and constructs search queries.

Server analyzes the structured data to determine which information storages are relevant, such as a product attribute database, a logistics database, or a policy document repository.

Server, based on the inferred intention, generates specific search queries; for a relational database, server constructs SQL statements with predicates derived from the product or order identifiers and attribute types; for a document repository, server constructs search expressions using keywords and filters.

Server performs parameter binding or query construction using programmatic interfaces so that constants are placed in parameter slots, and the core query structure remains stable across requests.

The input of Step 6 is the structured data including the inquiry intention and target information from Step 5, and the output of Step 6 is a set of prepared search queries targeted at one or more information storages.

### Step 7:

Server executes search queries and aggregates retrieved information.

Server sends each prepared search query to the corresponding information storage engine using a database driver or repository interface.

Server receives result sets that may include rows, documents, or key-value pairs, and then filters and normalizes these results to a unified format.

Server performs data processing operations such as deduplication, field selection, and type conversion so that only information relevant to the inquiry intention is retained.

Server aggregates the cleaned information into a compact representation, for example a list of attribute-value pairs or a short summary text, to be included in a prompt sentence.

The input of Step 7 is the set of search queries from Step 6, and the output of Step 7 is an aggregated information structure representing the information collection relevant to the inquiry.

### Step 8:

Server constructs a prompt sentence for a generative AI model.

Server combines the original inquiry sentence, the structured data, and the aggregated information into a single text block that serves as a prompt sentence.

Server appends explicit instructions specifying conditions and constraints, such as which information the generative AI model is allowed to use, the required response language, and the desired style and tone.

Server optionally incorporates dialogue history and user emotion information into the prompt sentence by adding summaries of prior turns and tone instructions.

The input of Step 8 is the original inquiry sentence, the structured data, the aggregated information, and any relevant dialogue history and emotion signals, and the output of Step 8 is a fully constructed prompt sentence ready for submission to the generative AI model.

### Step 9:

Server transmits the prompt sentence to an external generative AI model providing apparatus.

Server formats the prompt sentence along with model parameters (such as maximum response length and randomness level) into a request message compatible with the external apparatus.

Server sends this message through a secure communication channel to the apparatus that hosts the generative AI model.

Server starts a timer or tracking mechanism to measure response latency and resource usage associated with this model invocation.

The input of Step 9 is the prompt sentence generated in Step 8 and associated invocation parameters, and the output of Step 9 is the transmission of this prompt sentence to the external apparatus and the initiation of a model execution request.

### Step 10:

Server receives an answer sentence from the generative AI model and parses the response.

Server obtains a response message from the external apparatus and extracts the generated text content designated as the answer sentence.

Server may also extract metadata from the response, such as token counts, generation duration, or confidence indicators if provided.

Server stores the raw answer sentence and metadata in memory as part of a temporary response object for further processing.

The input of Step 10 is the response message from the external generative AI model providing apparatus, and the output of Step 10 is a parsed answer sentence and associated metadata held in server memory.

### Step 11:

Server checks consistency between the answer sentence and the retrieved information.

Server processes the answer sentence to identify key factual elements, such as product attributes, numerical values, and date expressions.

Server compares these elements against the aggregated information derived from the information storages, using operations such as string matching, numerical comparison, and semantic similarity computation.

Server determines whether the answer sentence contains any elements that are not supported by or are contradictory to the aggregated information.

The input of Step 11 is the answer sentence from Step 10 and the aggregated information from Step 7, and the output of Step 11 is a consistency assessment indicating whether the answer is acceptable or requires correction.

### Step 12:

Server regenerates and resubmits the prompt sentence when inconsistency is detected.

Server, upon detecting inconsistency, modifies the original prompt sentence by adding stronger constraints or clarifications, such as instructions to avoid unspecified attributes or to explicitly mention missing information.

Server constructs an updated prompt sentence that references the problematic sections of the earlier answer and reemphasizes the allowed data sources.

Server then repeats the transmission operation to the external apparatus, causing the generative AI model to generate a corrected answer sentence.

The input of Step 12 is the initial prompt sentence, the consistency assessment from Step 11, and the aggregated information, and the output of Step 12 is a revised prompt sentence submission and a newly generated answer sentence that is expected to be consistent.

### Step 13:

Server adjusts expression style and response tone based on user emotion and dialogue history.

Server analyzes stored emotion labels and dialogue history entries associated with the current user or session to determine a desired tone, such as apologetic, neutral, or friendly.

Server incorporates this tone decision into the prompt sentence used either in the initial model invocation or during regeneration, by adding explicit textual instructions about how the answer should be phrased.

Server ensures that the final answer sentence, as generated in response to these instructions, reflects the intended style by checking for the presence of polite phrases, supportive language, or other stylistic markers.

The input of Step 13 is the dialogue history, emotion information, and current answer generation context, and the output of Step 13 is an answer sentence that is both factually consistent and stylistically adapted to user emotion.

### Step 14:

Server generates a response payload and transmits it to the terminal.

Server packages the final answer sentence and optionally additional information such as reference identifiers or explanation notes into a structured response format.

Server sets appropriate response codes and headers and sends the response payload over the established network connection to the terminal.

Server updates internal logs with details of the processing, including query identifiers, prompt characteristics, model performance metrics, and consistency check results.

The input of Step 14 is the finalized answer sentence and internal context data, and the output of Step 14 is a transmitted response payload and an updated set of processing logs.

### Step 15:

Terminal receives the response payload and renders the answer.

Terminal receives the response from the server via the communication interface, verifies the payload integrity, and parses the structured content to extract the answer sentence and associated metadata.

Terminal updates the user interface by displaying the answer sentence in a dialog area and adjusting layout elements such as scroll position and message ordering.

Terminal optionally stores the displayed answer and related metadata locally as part of a conversation history for offline viewing or future context.

The input of Step 15 is the response payload sent from the server, and the output of Step 15 is a visually rendered answer on the terminal display and an updated local conversation history.

### Step 16:

User reviews the answer and optionally initiates a follow-up inquiry.

User reads the answer presented on the terminal and evaluates whether it addresses the original information need.

User, if not satisfied or in need of more detail, formulates a new natural language inquiry sentence that may reference aspects of the previous answer.

User inputs this new inquiry via the terminal interface, causing a new iteration of the processing sequence beginning with capturing and transmitting the updated inquiry to the server.

The input of Step 16 is the answer displayed on the terminal and the user's information need, and the output of Step 16 is a new inquiry sentence that re-enters the processing flow.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional incident notification and customer support systems largely rely on predefined templates and manually written messages. When a failure occurs in an information processing apparatus or a communication apparatus, an operator typically must collect technical data from multiple monitoring and logging systems, interpret the data, draft a customer-facing explanation, and then distribute the notification through appropriate communication channels. This workflow is time-consuming, error-prone, and highly dependent on the individual skills of the operator. As a result, customer notifications are often delayed, inconsistent in quality, and not sufficiently adapted to the customer's level of understanding or emotional state.

Furthermore, existing systems that incorporate natural language processing or generative models are usually designed only to answer static inquiries. They are not tightly integrated with real-time monitoring infrastructure, structured incident data, or automated message generation pipelines. In many cases, the generative model is invoked with ad hoc or simplistic input text, without leveraging rich structured failure information such as failure type, impact range, occurrence time, or estimated recovery time. Consequently, the generated messages may omit critical operational details, may fail to reflect up-to-date status, or may require extensive post-editing by human operators.

In addition, conventional systems do not adequately adapt the generated content based on the emotional state of the user or customer. Even when sentiment analysis is performed, the result is rarely fed back into the generation process in a systematic way. This leads to situations where technically correct messages are delivered in a tone that is perceived as insensitive, overly technical, or insufficiently reassuring, thereby degrading user experience and trust.

From a computer technology perspective, there is a need for an improved architecture that tightly couples: (i) automatic detection and collection of structured failure information from monitoring and logging components; (ii) generation of prompt sentences that encode this structured information as input instructions to a generative AI model; and (iii) automatic generation and delivery of response messages and notification messages that are dynamically adapted to user emotions. Without such an integrated architecture, computing resources are not efficiently utilized, the potential of generative AI models is not fully exploited, and operators cannot effectively offload repetitive communication tasks to the system.

Accordingly, there is a demand for a technical solution that improves the functioning of computer systems by automatically transforming low-level monitoring data and failure records into high-level, user-facing notifications through a structured prompt generation mechanism, and by closing the loop with emotion-aware adjustment of the generated content.

This improvement should reduce operator workload, shorten notification latency, enhance the consistency and appropriateness of system-generated communications, and thereby improve the overall performance and reliability of incident communication in computer networks and information processing environments.

The specific processing by the specific processing unit 290 of the data processing device 12 in Example 2 is realized by the following means.

The present invention provides a server comprising a processor configured to receive inquiry information or failure-related information from a user or a customer, analyze the inquiry information by using a natural language processing technique to understand an intention of the inquiry information, refer to an information storage unit and obtain related information based on an analysis result or the failure-related information, monitor an operational state of an information processing apparatus or a communication apparatus and detect occurrence of a failure in the information processing apparatus or the communication apparatus, in response to detection of the failure collect failure information including at least a failure type, an impact range, an occurrence time, and an estimated recovery time, structure the collected failure information as structured data and store the structured data in a storage unit, generate a prompt sentence including the related information or the stored failure information and instructing a generative AI model to generate, in natural language, a response to the inquiry information or a notification regarding the failure, input the prompt sentence into the generative AI model to cause the generative AI model to generate a response message or a notification message, transmit the generated response message or the generated notification message to a user terminal or a customer terminal via a communication function, and analyze response information or utterance content from the user, estimate an emotional state of the user, and adjust content or expression of the response message or the notification message in accordance with the estimated emotional state. This enables the server to automatically transform real-time monitoring data and structured failure records into context-rich prompt sentences for a generative AI model, to generate and deliver timely and tailored notification messages without operator intervention, and to improve computer functionality by integrating monitoring, data structuring, prompt generation, and emotion-aware message adaptation into a unified technical workflow.

The term “processor” refers to a hardware computation unit, such as a central processing unit or an execution core, that executes program instructions to perform the functions described in the present specification and claims.

The term “information processing apparatus” refers to an electronic device, such as a server apparatus, a client apparatus, or an application execution apparatus, that performs computation, data storage, or data communication by executing software.

The term “communication apparatus” refers to an electronic device, such as a network apparatus or a communication interface apparatus, that performs transmission and reception of data over a communication network.

The term “user terminal” refers to an end-user device, such as a personal computer, a tablet device, or a mobile communication device, that a user operates to transmit or receive information to or from the system.

The term “customer terminal” refers to an end-user device operated by a customer of a service, such as a personal computer, a mobile communication device, or another client device, that communicates with the system.

The term “information storage unit” refers to a logical storage component, such as a memory unit or a database unit, that stores information resources including inquiry-related data, failure-related data, configuration data, and historical records.

The term “storage unit” refers to a data storage component, such as a non-volatile storage device, a database system, or a storage subsystem, that stores structured data including failure information and incident records.

The term “monitoring function” refers to a software or hardware mechanism that periodically or continuously acquires operational state information of an information processing apparatus or a communication apparatus and evaluates the operational state to detect occurrence of a failure or an abnormal condition.

The term “failure” refers to a condition in which an information processing apparatus or a communication apparatus does not operate in accordance with an expected specification, including service outage, performance degradation, communication interruption, or functional error.

The term “failure-related information” refers to information describing a failure, including at least a failure type, an impact range, an occurrence time, an estimated recovery time, and other associated status data.

The term “failure type” refers to a classification of a failure, such as a network failure, a processing failure, a storage failure, or a software error, indicating a category of the abnormal condition.

The term “impact range” refers to a scope of influence of a failure, including at least affected components, affected services, affected users, or affected regions.

The term “occurrence time” refers to a time point or time period at which a failure is detected as having started or is determined to have occurred.

The term “estimated recovery time” refers to a time point or time period predicted or planned for restoration of normal operation of an information processing apparatus or a communication apparatus after a failure.

The term “structured data” refers to data that is organized according to a predetermined schema, such as records, fields, and data types, enabling systematic storage, retrieval, and processing by the system.

The term “inquiry information” refers to natural language content, including questions, requests, or problem reports, transmitted from a user or a customer to the system.

The term “natural language processing technique” refers to a computational method for processing human language expressions, including parsing, intent recognition, entity extraction, and semantic analysis, to derive a machine-usable representation.

The term “generative AI model” refers to a trained machine learning model, such as a large language model, that receives a prompt sentence as input and generates natural language text as output based on statistical patterns learned from training data.

The term “prompt sentence” refers to input text, including an explanatory text and a condition text, supplied to a generative AI model to instruct the generative AI model to generate a response message or a notification message in natural language.

The term “response message” refers to natural language text generated by the system in response to inquiry information from a user or a customer.

The term “notification message” refers to natural language text generated by the system for providing information regarding a failure, including at least a description of the failure, the impact range, and timing information.

The term “communication function” refers to a hardware and software combination that enables sending and receiving of data messages over a communication network using predetermined communication protocols.

The term “observation information source” refers to any component, such as a monitoring system, a log collection system, or a metrics collection system, that provides raw or processed operational data relating to an information processing apparatus or a communication apparatus.

The term “storage information source” refers to a storage component, such as a database system or a log storage system, that holds historical data, configuration data, and other stored information used to derive failure information.

The term “related information” refers to information obtained from the information storage unit that is relevant to inquiry information or failure-related information, including knowledge data, configuration data, or historical incident data.

The term “response information” refers to information returned from a user or a customer after receiving a response message or a notification message, including reply messages, feedback, and reaction content.

The term “utterance content” refers to textual or transcribed language data representing what a user or a customer has expressed in interaction with the system.

The term “emotional state” refers to an estimated psychological condition of a user or a customer, such as satisfaction, dissatisfaction, anxiety, or anger, inferred by analyzing response information or utterance content.

The term “condition text” refers to a part of a prompt sentence that explicitly specifies requirements, constraints, or tone for the generative AI model, such as politeness level, target audience, and inclusion of specific items.

The term “explanatory text” refers to a part of a prompt sentence that describes factual context, including failure type, impact range, occurrence time, and estimated recovery time, for use by the generative AI model in generating a message.

In one embodiment, a server executes a program stored in a non-transitory computer-readable storage medium to realize the claimed system. The server includes a processor, a main memory, a non-volatile storage device, and one or more network interfaces connected to a communication network. The server runs an operating system, monitoring software, an application framework, a database management system, and an inference framework for a generative AI model. A terminal, such as a personal computer or a mobile communication device, communicates with the server via the communication network. A user operates the terminal to submit inquiry information and to receive response messages and notification messages.

The server uses monitoring software, such as a general monitoring agent or plugin running on the operating system, to acquire operational state data from an information processing apparatus and a communication apparatus. The server acquires metrics including CPU utilization, memory usage, network throughput, error counts, and response latency from monitored components. The server also acquires log data from log collection software and metrics data from a metrics collection system. The server stores these data sets as time-series records and log records in a database management system such as a relational database or a key-value store.

The server uses a natural language processing module implemented on the application framework to analyze inquiry information and user utterance content. The server tokenizes inquiry text, applies part-of-speech tagging, performs syntactic parsing, and extracts semantic features, such as intent labels and named entities. The server represents inquiry information internally as a structured data object including at least an intent field, an entity list, and confidence scores. The server stores this data object in the information storage unit and uses it as input for subsequent processing.

The server uses the monitoring software to detect failures of the information processing apparatus or the communication apparatus. The server compares the acquired metrics with predetermined threshold values and applies anomaly detection algorithms, such as moving-average-based detection or standard-deviation-based detection, to determine whether a metric indicates an abnormal state. For example, the server determines that a network outage has occurred when a packet loss metric exceeds a threshold for a continuous time period. The server also analyzes error codes and log messages from the monitored components using pattern matching rules to classify a failure type. The server creates failure-related information including a failure type, an impact range, an occurrence time, and an estimated recovery time.

The server stores the failure-related information as structured data in the storage unit.

The server retrieves related information from the information storage unit based on the analyzed inquiry information or the failure-related information. For example, the server derives a query condition from an intent label and retrieves knowledge entries, configuration records, and historical incident records from the database. The server aggregates these records into a unified data structure that contains explanation text fragments, parameter values, and status information. The server formats this unified data structure to be used as part of a prompt sentence.

The server constructs a prompt sentence that serves as input to a generative AI model. The server places explanatory text describing the failure type, the impact range, the occurrence time, and the estimated recovery time in a first portion of the prompt sentence, and places condition text specifying message style, tone, and required content elements in a second portion of the prompt sentence. The server uses string concatenation, template expansion, and placeholder substitution to generate the prompt sentence from stored templates and structured data fields. The server stores the generated prompt sentence in the storage unit and passes it as a character sequence to the generative AI model.

The server, in one embodiment, uses a generative AI model implemented as a transformer-based neural network. The server uses an inference framework to load model parameters from the non-volatile storage device into memory. The generative AI model includes an embedding layer that maps input tokens of the prompt sentence to continuous vector representations, a plurality of transformer blocks each including a multi-head self-attention mechanism and a position-wise feedforward network, and an output layer that generates a probability distribution over vocabulary tokens. The server uses pre-computed tokenization rules to segment the prompt sentence into tokens, converts tokens to input indices, and feeds the indices to the generative AI model. The server executes matrix multiplications and attention weight computations on general-purpose processors or accelerator hardware, such as graphics processing units. The server applies a decoding algorithm, such as greedy decoding or beam search, to select output tokens based on the probability distribution. The server concatenates generated tokens to form a response message or a notification message in natural language.

The server trains the generative AI model in advance using a corpus of incident reports, system status notifications, customer support dialogs, and general language data. The server uses a supervised or semi-supervised learning method in which prompt-response pairs are provided as training samples. The server defines a loss function such as cross-entropy between predicted token distributions and ground-truth tokens, and the server updates model weights using a gradient-based optimization algorithm such as stochastic gradient descent or an adaptive variant. The server may apply data augmentation techniques, such as paraphrasing, synonym replacement, or template-based expansion, to increase the variety of training samples. The server stores the trained model parameters in the storage unit for later inference. By training the model on domain-specific failure descriptions and notifications, the server improves the accuracy and consistency of generated messages in the context of system failures.

The server, in an alternative embodiment, uses a hybrid architecture where a smaller, domain-specific generative AI model is fine-tuned with failure-related data, and a larger, general-purpose generative AI model is used for fallback. The server selects between these models based on a rule, for example: use the domain-specific model when structured failure information is available, and use the general-purpose model when only generic inquiry information is present. This configuration enables the server to improve computation efficiency by using smaller models for routine incident notifications while retaining flexibility for broader customer support scenarios.

The server generates response messages and notification messages using the generative AI model. For example, when the server detects a network failure, the server constructs a prompt sentence such as:

“An incident has occurred in our service.

Type: network outage

Impact: customers in the East region cannot access the web front-end.

Start time: 2026-01-30T10:05:00Z

Estimated recovery time: 2026-01-30T11:00:00Z

Please act as a customer support representative and generate a clear and polite email notification for customers. The email should include:
1) a brief explanation of the incident,
2) the affected services or regions,
3) the estimated recovery time, and
4) an apology and reassurance about our efforts to resolve the issue.”

The server inputs this prompt sentence into the generative AI model and obtains as output a natural language notification message. The server may perform post-processing on the generated text, including removal of undesirable patterns, enforcement of maximum length, insertion of disclaimers, and alignment with corporate style guidelines. The server logs the generated message along with metadata such as the prompt sentence, model version, and generation parameters for audit and reproducibility.

The server delivers the response messages and notification messages to user terminals and customer terminals via a communication function. The server uses transport protocols such as SMTP for email, HTTPS for web-based messaging, or push notification protocols for mobile applications. The server retrieves destination addresses and user identifiers from a user database. The server batch-schedules outgoing messages and optimizes the order and grouping of messages to reduce network load, for example by aggregating messages per domain or by limiting peak send rate. As a result, the server reduces communication load on network resources and prevents congestion during large-scale incidents.

The server receives response information and utterance content from users and customers via the communication network. The server aggregates these inputs and applies a sentiment analysis module to estimate emotional states. The server uses feature extraction techniques, such as n-gram frequency analysis, lexical sentiment scoring, and transformer-based sentence embeddings, to derive feature vectors from response text. The server inputs the feature vectors into a classification model, such as a neural network classifier or a support vector machine, trained to output emotion categories such as satisfaction, frustration, or anxiety. The server stores the estimated emotional state in association with the user identifier and the incident identifier.

The server uses the estimated emotional state to adjust content or expression of future response messages and notification messages. The server modifies parameters of the prompt sentence, such as specifying a more empathetic tone, adding additional reassurance, or including more technical detail for expert users. For example, if the server determines that many customers display a high level of anxiety, the server constructs a prompt sentence that explicitly requests a more detailed explanation and stronger reassurance. This adaptive prompt generation constitutes a specific technical mechanism for using emotion analysis outcomes to modify input conditions for the generative AI model, thereby changing the behavior of the model in a systematic way that improves user comprehension and satisfaction.

The server implements non-conventional processing rules that differ from simple human drafting. For example, the server uses rule-based logic to select specific subsets of structured failure information to include in the prompt sentence, such as limiting the number of technical terms or ensuring inclusion of the most recent estimated recovery time. The server also uses a ranking algorithm to prioritize which incidents require immediate notification based on severity scores and impact metrics. These rules enable the server to avoid generating redundant or obsolete notifications and to optimize computational resources by controlling the number of generative AI model calls.

The server improves computer technology in several ways. First, the server converts low-level monitoring data and log records into structured failure-related information using a defined schema and processing pipeline, thereby improving data management and enabling efficient indexing, retrieval, and reuse of incident information. Second, the server reduces latency in incident communication by automatically triggering prompt generation and message generation immediately upon failure detection, eliminating delays introduced by manual draft preparation. Third, the server reduces computational load by reusing structured failure information to generate multiple language variants or audience-specific messages without re-running expensive data collection steps. Fourth, the server improves accuracy and consistency of messages by integrating domain-specific structured fields into prompt sentences, leading to fewer omissions and more precise descriptions compared to ad hoc human writing. Fifth, the server reduces network traffic spikes by scheduling and grouping outgoing messages based on batch-sending policies implemented in the communication function.

The server, in further embodiments, controls external devices or systems based on generated messages. For example, the server may update a status display system such as a dashboard or a large-screen monitor by sending a structured notification payload, or may trigger configuration changes in load balancers or routing devices by invoking management APIs when a specific failure type is detected. In such embodiments, integration of monitoring, structured failure modeling, and generative message production contributes not only to user communication but also to automated adaptation of the underlying infrastructure.

The terminal receives response messages and notification messages from the server, displays the messages on a user interface, and optionally sends feedback or further inquiries back to the server. The terminal renders messages along with meta-information such as incident identifiers, timestamps, and severity indicators. The user reads the displayed messages and can take appropriate actions, such as adjusting operations, informing internal stakeholders, or monitoring recovery progress. The user may provide feedback or corrections, which the server can log and use for further training or rule refinement.

The server, in optional embodiments, supports multiple generative AI models and dynamically selects a model based on device constraints, cost constraints, or required response time. For example, the server uses a smaller model for real-time notifications on resource-constrained devices and a larger model for detailed reports requested by administrators. The server also adjusts generation parameters such as maximum token length, temperature, and top-k settings to balance computational cost and quality of generated text.

These adaptive strategies provide improved computational efficiency and reduced processing time compared to fixed, one-size-fits-all configurations.

Through these embodiments, the server implements a tightly integrated system that acquires and structures failure-related information, generates prompt sentences that encode this information together with explicit generation conditions, and uses a generative AI model with defined architecture and training procedures to generate and adapt response messages and notification messages. This integration provides a specific improvement in computer functionality by reducing processing latency, increasing accuracy and consistency of generated content, optimizing resource usage, and enabling emotion-aware adaptation that is difficult to achieve with conventional, static template-based or purely manual approaches.

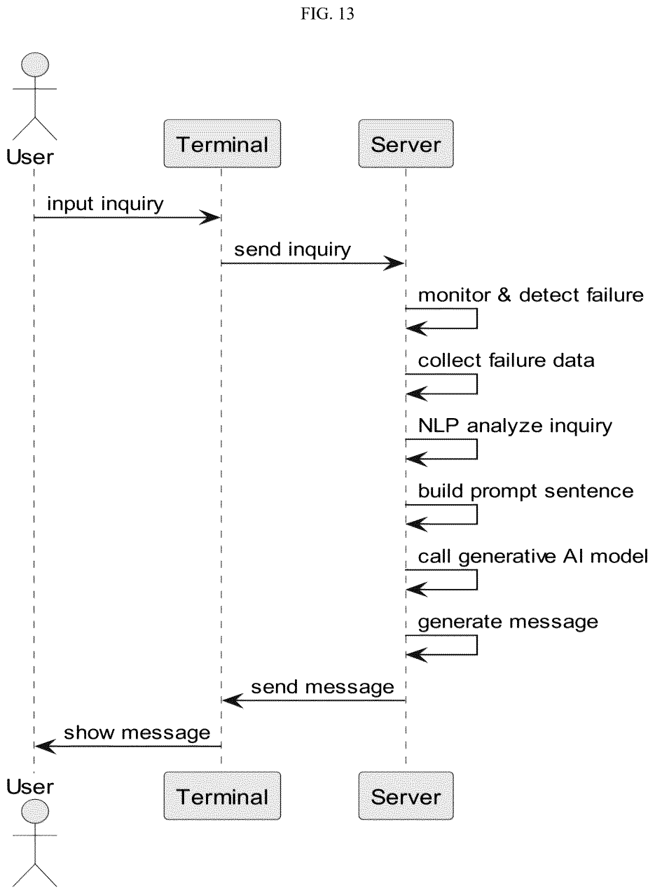

The following describes the processing flow using FIG. 13.

### Step 1:

Server initializes system components and data structures.

Server loads configuration files, threshold values, template definitions for a prompt sentence, and model selection rules from a storage unit into main memory.

Server starts monitoring software, a database management system, a natural language processing module, and a generative AI model inference module.

Input: configuration data and program code stored in non-volatile storage.

Server parses the configuration data, constructs in-memory data structures such as threshold tables, template maps, and routing rules, and registers them in a configuration registry.

Output: initialized runtime environment in which subsequent processing modules can operate with access to configuration and templates.

### Step 2:

Server collects operational state data of an information processing apparatus and a communication apparatus.

Server uses monitoring software to periodically poll or receive metrics such as CPU usage, memory usage, network packet counts, error codes, and response time from monitored components.

Input: raw metric readings and status responses from monitored components.

Server normalizes metric units, timestamps each reading, and converts raw values into a standardized internal format, then stores the normalized records in a metrics table of the database.

Output: standardized time-series metrics stored in the database and accessible for later failure detection.

### Step 3:

Server detects a failure based on the collected operational state data.

Server compares each metric against corresponding threshold values and applies anomaly detection algorithms, such as moving average deviation or rate-of-change analysis, to determine abnormal conditions.

Input: normalized metrics and threshold tables loaded in Step 1.

Server executes arithmetic operations (subtraction, division, standard deviation) on metric windows, evaluates condition expressions, and sets a failure flag when a rule is satisfied.

Output: a failure detection event object including at least a failure type candidate, affected component identifiers, and detection time.

### Step 4:

Server classifies the detected failure and constructs initial failure-related information.

Server uses rule-based mappings and pattern matching on metric names, error codes, and log snippets to determine a failure type and an impact range.

Input: failure detection event, error codes, and relevant log excerpts.

Server executes string pattern matching, table lookups, and conditional branching to map raw error information to higher-level labels such as “network outage” or “database failure,” and estimates an impact range, such as affected services or regions.

Output: a structured failure-related data object including failure type, impact range, occurrence time, and pointers to relevant raw data.

### Step 5:

Server enriches failure-related information using external observation and storage sources.

Server queries a log storage system and a metrics database for records around the occurrence time using time-window queries.

Input: the structured failure-related data object containing occurrence time and component identifiers.

Server applies filter conditions on timestamps and component identifiers, aggregates error counts, and extracts representative error messages or stack traces, then attaches this information to the failure-related data object.

Output: an enriched failure-related data object that includes detailed context for the failure.

### Step 6:

Server stores the enriched failure-related information as structured data.

Server opens a transaction on the database and writes the enriched failure-related data object into an incident table with fields such as incident_id, type, scope, start_time, and estimated_recovery_time.

Input: enriched failure-related data object.

Server converts internal object fields into column values, prepares an INSERT or UPDATE statement, and executes the statement, ensuring referential integrity with related tables such as incident_history.

Output: a persistent incident record with a unique incident identifier stored in the storage unit.

### Step 7:

Server receives inquiry information or user messages.

Server exposes an API endpoint or a user interface for a terminal to send natural language inquiries or responses.

Input: text content including questions, feedback, or reactions provided by the user through the terminal.

Server validates the input format, removes unsupported characters, and stores the raw text and metadata (user ID, time, channel) in a message table in the database.

Output: a stored inquiry record that can be processed by natural language processing modules.

### Step 8:

Server analyzes inquiry information and user utterance content using natural language processing.

Server tokenizes the text, performs part-of-speech tagging, syntactic parsing, and intent classification.

Input: the stored inquiry record containing raw text content.

Server applies language models and trained classifiers to compute feature vectors, intent probabilities, and entity lists; it then selects a dominant intent and associated entities based on maximum probability or a predefined threshold.

Output: an inquiry analysis result object that includes intent label, entity list, and confidence scores.

### Step 9:

Server estimates the emotional state of the user.

Server uses a sentiment analysis model or classifier that takes the inquiry text and contextual messages as input features.

Input: raw text of user messages, n-gram features, and embeddings derived from previous interactions.

Server computes sentiment scores and emotion category probabilities, compares them to decision thresholds, and assigns an emotional state label such as “calm,” “frustrated,” or “anxious.”

Output: an emotional state object associated with the user and the corresponding incident or conversation.

### Step 10:

Server retrieves related information from the information storage unit.

Server formulates a query condition based on the intent label, entity list, failure type, and incident identifier.

Input: inquiry analysis result object and incident record stored in the database.

Server executes database queries to obtain relevant knowledge entries, historical incident summaries, configuration parameters, and current status fields, and combines the retrieved records into a unified context object.

Output: a related-information context object containing factual text fragments and parameter values for inclusion in a prompt sentence.

### Step 11:

Server constructs a prompt sentence for the generative AI model.

Server selects a template appropriate for the detected failure type or inquiry intent and then substitutes placeholders with concrete values from the related-information context object and the failure-related data.

Input: related-information context object, emotional state object, and template definitions.

Server performs string concatenation, conditional insertion (e.g., including more reassurance when the emotional state is “anxious”), and formatting operations to generate a coherent, multi-line prompt sentence.

Output: a prompt sentence in natural language that encodes both factual information and generation instructions.

### Step 12:

Server selects a generative AI model and configures generation parameters.

Server applies selection rules that inspect failure type, message length requirements, and latency constraints.

Input: prompt sentence and system configuration parameters.

Server chooses a specific model instance (e.g., a domain-specific model or a general model), sets generation parameters such as maximum token count, temperature, and decoding strategy (greedy or beam search), and records these selections for logging.

Output: a model invocation configuration object coupled with the prompt sentence.

### Step 13:

Server executes inference on the generative AI model using the prompt sentence.

Server tokenizes the prompt sentence into tokens, maps tokens to numerical indices, and feeds these indices into the neural network.

Input: prompt sentence and model invocation configuration object.

Server performs a series of matrix multiplications and attention computations across multiple transformer layers, computes a probability distribution over tokens at each generation step, and iteratively selects output tokens according to the decoding strategy until an end-of-sequence condition is reached.

Output: a generated token sequence representing a response message or notification message.

### Step 14:

Server converts the generated token sequence into a natural language message and applies post-processing.

Server maps output token indices back to text tokens, concatenates them into a string, and removes control tokens or artifacts.

Input: generated token sequence.

Server applies normalization rules such as trimming whitespace, enforcing character encoding, checking for forbidden phrases, and inserting standard headers or footers, then stores the final message text in the database.

Output: a finalized response message or notification message in natural language.

### Step 15:

Server prepares delivery of the response message or notification message.

Server determines recipient addresses based on incident scope, user identifiers, and subscription settings.

Input: finalized message text and recipient list from user and customer databases.

Server constructs communication payloads, such as email messages with subject lines and headers, or HTTP response bodies for web-based interfaces, and associates the payloads with the appropriate transport channels.

Output: fully composed communication units ready to be transmitted over the network.

### Step 16:

Server transmits the response message or notification message to terminals.

Server uses communication protocols such as SMTP, HTTPS, or push notification protocols to send the composed communication units to user terminals and customer terminals.

Input: composed communication units and network routing information.

Server opens network connections, performs necessary handshakes, sends data packets, and logs transmission results, including success or failure status codes and timestamps.

Output: messages delivered to terminals or queued for retry, with transmission logs recorded.

### Step 17:

Terminal receives and displays the response message or notification message.

Terminal connects to a mail server or web server and retrieves incoming messages.

Input: communication data packets received over the network.

Terminal decodes message headers and bodies, converts them into displayable text, and renders them in a user interface including subject, body text, and any metadata such as incident identifiers.

Output: a visual representation of the message on the terminal screen for the user to read.

### Step 18:

User reads the displayed message and optionally provides a follow-up response.

User interprets the explanation of the failure, impact range, and estimated recovery time and decides whether to send additional questions or feedback.

Input: visual content displayed on the terminal.

User, when providing feedback, enters natural language text via an input device, and the terminal sends this text back to the server as new inquiry information.

Output: user-generated follow-up text transmitted to the server for further processing.

### Step 19:

Server logs interaction data and updates models or rules if necessary.

Server records which prompt sentence and model configuration produced which generated message and logs subsequent user responses and emotional states.

Input: prompt sentences, generated messages, emotional state objects, and user feedback.

Server aggregates these records, computes statistics such as error rates, satisfaction indicators, and response times, and may update configuration parameters, thresholds, or training data sets for later retraining of the generative AI model or the emotion classifier.

Output: updated logs and, in some embodiments, improved model parameters or rule sets that refine future processing.

### Step 20:

Server optionally retrains or fine-tunes the generative AI model and auxiliary classifiers using accumulated data.

Server constructs training batches from logged prompt-response pairs and labeled emotional states.

Input: stored interaction logs and labeled data sets.

Server computes gradients of a loss function, such as cross-entropy for language modeling or classification loss for emotion estimation, updates model weights using an optimization algorithm, and then saves updated parameters back to the storage unit.

Output: refined models that provide improved generation accuracy, better emotional adaptation, and higher overall system performance in subsequent executions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented customer support systems typically follow a rigid pipeline in which user inputs are classified, matched against fixed rules or frequently-asked-question entries, and returned as static responses. In such systems, a processor generally treats logs, database records, and user messages as separate data streams, without jointly reasoning over: (i) the technical state of an information processing environment (for example, failures and recovery status), (ii) user-specific emotional state, and (iii) dynamically generated natural-language explanations. As a result, these systems suffer from several technical limitations.

First, existing response-generation engines often embed all language logic in procedural code or template rules executed on a processor, which requires frequent manual updates and does not adapt well to unseen user inputs. When system conditions change rapidly, such as during a failure or a large-scale incident, the processor cannot easily synthesize up-to-date explanations from heterogeneous log streams and internal records, leading to outdated or inconsistent messages. This degrades the effectiveness of human-computer interaction and causes unnecessary load on communication channels and back-end resources.

Second, conventional architectures do not tightly integrate emotion analysis with response generation at the system level. Emotion detection modules, if present, are typically used only for reporting or coarse routing and are not structurally linked to the core logic that composes outgoing messages. The processor therefore fails to adapt expression style, politeness level, or content selection according to a user's emotional state. This causes inefficient dialogues: users repeat similar questions, sessions become longer, and more server and network resources are consumed for each issue. From a computer-technology perspective, the interaction loop between emotion analysis and response generation remains under-utilized and sub-optimally coordinated.

Third, existing failure notification systems tend to broadcast generic, prewritten messages that do not exploit the full structure of machine-readable log data and historical incident records. In many implementations, a monitoring process simply detects a threshold breach, triggers a template message, and sends it through a notification service. The processor in such systems does not perform advanced data fusion across log streams, configuration tables, and past incident histories to estimate recovery time and construct context-aware explanations.

Consequently, end-user devices receive coarse-grained notifications, users continue to query support channels, and operators are forced to manually clarify status. This leads to redundant processing on both client and server hardware and an overall decrease in system throughput.

Fourth, in environments such as physical stores using wearable terminals, existing systems often split processing into separate, loosely coupled subsystems for speech recognition, emotion estimation, and suggestion display. Data handoff between these components is typically ad hoc, without a unified, processor-level representation that can be directly consumed by a generative model. As a result, the processor cannot consistently generate response texts that simultaneously reflect: real-time speech transcripts, facial-expression-based emotion states, and internal knowledge. This fragmentation reduces the quality and speed of generated assistance and wastes compute cycles in repeated, uncoordinated processing.

Accordingly, there is a need for an improved computer-implemented system in which a processor: (i) jointly analyzes inquiry information and operation-status information, (ii) integrates internal records and historical data to estimate recovery times or response policies, (iii) synthesizes a structured representation that includes emotion states, technical states, and knowledge elements, and (iv) uses this structured representation to generate and refine prompt sentences for a generative AI model. By closing the loop with feedback information from user terminals, such a system should enable more efficient use of computational resources, reduce redundant user interactions, and technically improve the behavior of the dialog and notification subsystem running on the processor.

The specific processing by the specific processing unit 290 of the data processing device 12 in Application Example 2 is realized by the following means.

The present invention provides a server comprising a processor configured to receive inquiry information or operation status information from a user terminal, to analyze character string data and log information included in the received information by using natural language processing technology and information analysis technology so as to specify an inquiry intent or an abnormal state, to refer, based on the specified inquiry intent or abnormal state, to information records stored in an information storage apparatus and acquire related information elements and past history information, to estimate a recovery time or a response policy based on the acquired information elements and the past history information and generate structured data including a result of the estimation, to generate a prompt sentence including an instruction text to be input to a generative AI model based on the structured data and an analyzed emotional state of a user, to input the generated prompt sentence to the generative AI model and cause the generative AI model to generate a response text according to the inquiry intent or the abnormal state and the emotional state of the user, to obtain the generated response text and adjust an expression content or a politeness level of the response text based on the emotional state of the user and a predetermined response policy, to generate notification information including the adjusted response text and transmit the notification information to the user terminal via a communication network, and to collect feedback information and emotion analysis results transmitted from the user terminal and update, in a learning manner, a prompt sentence generation process or a response text adjustment process.

This enables the server-side processor to integrate heterogeneous technical and user-interaction data into a unified structured representation that directly conditions a generative AI model, thereby improving the efficiency and adaptability of computer-implemented dialog and notification functions, reducing unnecessary processing load caused by repeated or ineffective responses, and technically enhancing the overall behavior of the information processing system.

The term “inquiry information” refers to information that represents a request, question, complaint, or other communication transmitted from a user or user terminal to the server, and includes at least character string data entered by the user and metadata associated with the communication.

The term “operation status information” refers to information that represents a state, condition, or performance of an information processing environment, and includes at least log information, monitoring metrics, and event records generated by hardware or software components.

The term “log information” refers to time-stamped records output by an information processing apparatus or program, the records including messages, codes, and parameters that describe events, errors, or state transitions of the apparatus or program.

The term “natural language processing technology” refers to a set of algorithms and programs executed by the processor to analyze and process human-readable text, including at least tokenization, part-of-speech tagging, entity extraction, syntactic analysis, semantic analysis, and intent detection.

The term “information analysis technology” refers to a set of algorithms and programs executed by the processor to process structured or semi-structured data, including at least statistical analysis, pattern detection, anomaly detection, and correlation analysis of operation status information and related records.

The term “inquiry intent” refers to a logical representation of a purpose, request type, or problem category inferred from inquiry information by the processor using natural language processing technology and information analysis technology.

The term “abnormal state” refers to a condition of an information processing environment that deviates from a normal operation range, the condition being detected or inferred from operation status information and log information by the processor.

The term “information records” refers to data stored in an information storage apparatus, including at least configuration data, manuals, frequently asked question entries, incident histories, and other knowledge items relevant to inquiries or abnormal states.

The term “information storage apparatus” refers to a hardware and software combination that stores information records, and includes at least a memory device, a storage device, and a database management program.

The term “information elements” refers to individual pieces of information obtained from information records, including at least textual descriptions, parameter values, configuration attributes, and identifiers related to a particular inquiry intent or abnormal state.

The term “past history information” refers to information elements that describe past events, past inquiries, or past abnormal states, including at least previous incident records, previous responses, and previously estimated or measured recovery times.

The term “recovery time” refers to a time value estimated or determined by the processor that indicates a predicted or target time required to return from an abnormal state to a normal operation state.

The term “response policy” refers to a rule set or parameter set used by the processor to select, prioritize, or constrain contents and styles of responses generated for a user, the rule set or parameter set being determined based on system conditions, user attributes, and emotion states.

The term “structured data” refers to data represented in a machine-interpretable format, such as a record, table, or tree, the data including at least fields corresponding to an inquiry intent, an abnormal state, a recovery time, a response policy, and an emotion state.

The term “emotional state” refers to a classification or quantitative representation of a user's emotion, including at least anger, frustration, anxiety, sadness, neutrality, and joy, the classification or representation being derived from inquiry information and optionally from voice, facial expression, or other signals.

The term “generative AI model” refers to an artificial intelligence model that receives a prompt sentence as input and outputs generated natural-language text, the model being trained on large corpora and being capable of producing context-dependent responses.

The term “prompt sentence” refers to a text sequence generated by the processor that includes at least an instruction, context information, and one or more data elements derived from structured data, the text sequence being provided as input to the generative AI model to condition generation of a response text.

The term “response text” refers to natural-language text output by the generative AI model in response to a prompt sentence, the text being intended to be transmitted, possibly after adjustment, as at least part of a response or notification to a user.

The term “expression content” refers to semantic and lexical components of a response text, including at least selected information items, phrasing, sentence structure, and level of detail.

The term “politeness level” refers to a style parameter of a response text that specifies a degree of courtesy, formality, or deference expressed in natural language, the degree being adjusted based on an emotional state of the user and a response policy.

The term “notification information” refers to information generated by the processor that includes at least an adjusted response text and optional metadata, the information being formatted for delivery to one or more user terminals via a communication network.

The term “user terminal” refers to a computing apparatus operated by a user, including at least a mobile terminal, a wearable terminal, or a fixed terminal, the apparatus being configured to transmit inquiry information and to receive and present notification information.

The term “feedback information” refers to information transmitted from a user terminal to the server after delivery of a response text, including at least explicit feedback such as ratings or selections and implicit feedback such as follow-up messages or interaction patterns.

The term “emotion analysis result” refers to data output by an emotion determination process, including at least an emotional state label and optionally numerical scores representing intensities of one or more emotions.

The term “learning manner” refers to an operation mode in which the processor updates parameters, rules, or templates of a process by using feedback information and emotion analysis results, so that future behavior of the process is modified based on past interactions.

The term “prompt sentence generation process” refers to a sequence of operations executed by the processor to map structured data and emotion information to a prompt sentence, including at least template selection, text assembly, and parameter insertion.

The term “response text adjustment process” refers to a sequence of operations executed by the processor to modify a response text obtained from a generative AI model, including at least insertion or deletion of clauses, change of politeness level, and enforcement of a response policy.

The term “voice acquisition device” refers to a component of a user terminal that captures acoustic signals produced by a user, such as a microphone or equivalent sensor.

The term “image acquisition device” refers to a component of a user terminal that captures visual information related to a user, such as a camera or equivalent sensor.

The term “speech recognition technology” refers to algorithms and programs that convert voice information into character string data, including at least acoustic feature extraction, phonetic decoding, and language modeling.

The term “facial expression information” refers to image data or derived features representing movements or configurations of a user's face, the data or features being used to infer an emotional state.

The term “failure monitoring apparatus” refers to a combination of hardware and software that observes operation status information and log information of computing resources, and outputs data that allow detection of failures or abnormal states.

The term “failure type” refers to a classification of a detected abnormal state, such as a communication failure, storage failure, or processing failure, the classification being derived from operation status information and log information.

The term “failure notification text” refers to a response text generated by the generative AI model that describes a failure, a recovery time, and optional guidance, the text being intended for delivery to end users.

The term “notification service” refers to a software-based communication facility that distributes notification information or failure notification texts to one or more user terminals, and includes at least messaging servers, push-delivery components, and related protocols.

Server, terminal, and user cooperate to implement embodiments of the invention. In the following description, “server” denotes a data processing apparatus comprising at least one processor, memory, and storage device; “terminal” denotes a user-operated computing device such as a mobile device, wearable device, or fixed client; and “user” denotes a human operator of the terminal.

Server executes computer programs that are stored in a non-transitory storage medium and loaded into memory. Server uses general-purpose hardware, such as a multi-core central processing unit, a main memory, a non-volatile storage device, and a network interface, and may further include an accelerator such as a graphics processing unit for neural-network inference. Server executes middleware components including a network server program, a database management program, and one or more machine-learning frameworks. Server may, for example, use an operating system such as a general-purpose server operating system, a database engine such as a relational database management system, and a machine-learning framework such as a tensor-based computation library.

Terminal comprises at least a processor, memory, a display device, an input interface, and a communication interface. Terminal may be a smartphone, a tablet computer, a head-mounted display, or a desktop client. Terminal optionally includes a voice acquisition device, such as a microphone, and an image acquisition device, such as a camera, for capturing user voice and facial expressions. Terminal executes an application program that communicates with server via a packet network using a secure transport protocol.

User operates terminal to input inquiry information, complaints, or feedback, and to view or listen to response texts generated according to the present invention. User may, for example, enter text through a touchscreen keyboard, dictate speech via the microphone, or perform gestures captured by the camera.

Server maintains an information storage apparatus that stores information records relevant to inquiries and operation status. Information storage apparatus may include a relational database that stores structured tables such as user profiles, incident histories, frequently asked questions, configuration information, and failure logs. Server also maintains a log storage area that records operation status information, such as time-stamped event logs from monitored systems, resource usage metrics, and error reports. These records are indexed by identifiers and timestamps to allow efficient retrieval and correlation.

Server implements a natural language processing module that analyzes inquiry information received from terminal. The natural language processing module is implemented using a text-processing library and a neural-network-based classifier. The module converts incoming text into a sequence of tokens, performs part-of-speech tagging and syntactic parsing, extracts key phrases and named entities, and classifies the text into an “inquiry intent.” The inquiry intent describes a category such as “product malfunction,” “billing question,” or “system outage concern.” The module represents each token by an embedding vector and feeds the token sequence to a model such as a bidirectional recurrent neural network or a transformer encoder trained to output an intent label. The model is trained by supervised learning using a cross-entropy loss function and gradient-based weight updates.

Server further implements an information analysis module that processes operation status information and log information. The information analysis module uses pattern-matching rules and statistical models to detect abnormal states such as failures. The module reads log streams from log storage, parses each entry by splitting on delimiters and regular expressions, and detects error codes, patterns of repeated failures, or abnormal metric values. The module may maintain a sliding time window in memory and compute statistics such as the rate of certain error codes per minute. When the rate exceeds a threshold, the module classifies the situation as an abnormal state and assigns a failure type. The analysis module correlates logs from different components using timestamps and identifiers to identify a scope of impact.

Server, upon determining an inquiry intent or abnormal state, queries information records stored in the information storage apparatus. Server executes database queries that take tokenized keywords and intent labels as parameters and retrieve relevant entries, such as troubleshooting steps, configuration notes, or prior incidents of a similar failure type. Server may use full-text search indexes or vector similarity search to find the most relevant past cases. Server then constructs information elements and past history information, which are structured records that summarize retrieved data, including technical descriptions and previously observed recovery times.

Server estimates a recovery time or response policy based on the acquired information elements and past history information. For example, server may compute an average or a weighted median of past recovery durations for the same failure type, taking into account system configuration and time of day. Server may also use a regression model, such as a feed-forward neural network, that takes as input features extracted from log patterns and configuration data and outputs an estimated recovery time. The regression model is trained offline using historical incident data and an error function such as mean squared error. The processor stores the model parameters in memory and updates them when new training data become available.

Server constructs structured data that aggregates the inquiry intent, abnormal state, estimated recovery time, response policy, and emotion state. The structured data is represented, for example, as a record with fields identifying an inquiry identifier, a failure type, an estimated recovery time value, a set of relevant knowledge item identifiers, and one or more emotion labels. This structured representation forms a unified context that the server uses to guide later language generation.

Server implements an emotion analysis module that determines an emotional state of the user.

The module receives character string data from the user message and optionally receives additional signals such as voice features or facial expression features. For textual analysis, the module uses a neural classifier that processes token embeddings and outputs a probability distribution over emotion classes, such as anger, frustration, anxiety, neutrality, and joy. For voice analysis, the module extracts acoustic features, such as Mel-frequency cepstral coefficients and prosodic features, and applies a classifier trained to detect emotional tone.

For facial expressions, the module uses an image processing network, for example a convolutional neural network, that receives face images cropped from camera frames and outputs emotion scores. Server fuses these scores using a rule-based or weighted-average method to obtain a final emotional state label.

Server then generates a prompt sentence for a generative AI model. The prompt sentence is a natural-language instruction that conveys to the model the combined technical state, user intent, emotion state, and response policy. Server uses a template system to insert fields from the structured data into the prompt text. For example, when a failure in a security system occurs, server may construct a prompt sentence such as:

“The user message is: ‘Why is this taking so long?’. The detected emotion is anger. There is a failure in the security system affecting access control. The error type is a connection error and the estimated recovery time is 120 minutes. You are a customer support agent. Generate a polite response that includes: (1) a clear apology, (2) a brief explanation that the team is working on the issue, and (3) reassurance that the problem will be resolved within about 2 hours.”

In another example, when a customer in a store asks about stock status, server may construct a prompt sentence such as:

“The customer is slightly dissatisfied and asks: ‘When will this product be back in stock?’.

Generate a polite in-store response that includes an apology, an explanation that restocking is in progress, and an offer to notify the customer once the item arrives.”

In a further example involving general troubleshooting, server may construct a prompt sentence such as:

“User question: ‘My device stops working after 10 minutes. What should I do?’. Detected intent: troubleshooting a device that stops after a fixed time. Relevant internal information:

(1) Check the power settings, (2) Update firmware, (3) Perform a reset if the problem persists. The user seems worried. Using this information, generate a clear step-by-step troubleshooting answer with a reassuring and polite tone.”

Server provides the prompt sentence as input to a generative AI model. In one embodiment, the generative AI model is a transformer-based language model that has been pre-trained on large corpora of text and optionally fine-tuned on domain-specific data. The model comprises multiple layers of self-attention and feed-forward networks, each with a set of parameters (weights and biases). During inference, the model receives the prompt sentence as a sequence of token embeddings and applies attention mechanisms to compute context-dependent representations, then sequentially generates output tokens that form a response text. The server executes the inference either locally on its own hardware or via a dedicated AI inference service, transmitting the prompt and receiving the generated text over a network.

Server obtains the generated response text and applies a response text adjustment process.

The adjustment process inspects the content for compliance with response policy, such as including certain mandatory phrases, avoiding specific prohibited terms, or respecting a length constraint. The processor may, for example, scan the response text for keywords and phrases and replace or augment them. The adjustment process also modifies politeness level based on the emotional state label. For an angry user, server increases the number of apologetic expressions; for a neutral user, server reduces redundancy and returns a concise explanation. These adjustments may be performed with a rule engine that applies transformations depending on emotion labels and system status indicators.

Server generates notification information containing the adjusted response text and any relevant metadata, such as a timestamp, an incident identifier, or a link to a detailed status page. Server serializes the notification information in a transmission format suitable for the target delivery mechanism, such as a push notification service, a messaging protocol, or an email system. Server transmits the notification information via a communication network to one or multiple terminals.

Terminal receives notification information through a client application. In case of a mobile device, the client uses a push notification framework provided by the operating system.

Terminal decodes the incoming payload, extracts the response text, and displays it on the screen in a user interface element such as a notification banner or a chat bubble. In the case of a wearable terminal, such as smart glasses, terminal shows the text as an overlay in the user's field of view, optionally truncating or scrolling the text according to display size.

User views the response text and may optionally input feedback. Feedback information may include explicit ratings such as “helpful” or “not helpful,” free-form comments, or indirect signals such as whether the user continues to ask follow-up questions. Terminal collects this feedback and sends it to server. Server records feedback information and associated emotion analysis results in a feedback database. Server periodically or continuously uses this accumulated data to update parameters in the prompt sentence generation process and the response text adjustment process. For example, server may adjust template selection rules, update thresholds for politeness changes, or retrain a small model that predicts optimal length for explanations given intent and emotion.

In a particular embodiment related to in-store support, terminal is implemented as a head-mounted display worn by a store employee. Terminal includes an integrated microphone and camera as the voice acquisition device and image acquisition device. User (the customer) speaks a question such as “When will this product be back in stock?” and shows facial expressions that indicate dissatisfaction. Terminal records audio as a digital signal, segments it into fixed-length frames, and transmits the frames to server. Terminal captures video frames, performs preliminary face detection to obtain cropped regions, and sends those regions to server. Server executes speech recognition technology on the audio stream using a deep neural network acoustic model and a language model, converting speech into a text transcript. Server executes a facial expression recognition network on the image data to infer emotion scores. Server then performs prompt generation and response generation as described above, and terminal displays the resulting response text to the employee. This embodiment improves real-time human-computer interaction in a physical environment by offloading heavy inference to the server and using structured integration of transcript, emotion, and knowledge.

In another embodiment related to failure notification, server integrates with a failure monitoring apparatus that collects metrics and logs from various computing resources. The monitoring apparatus streams operation status information to server. Server runs the information analysis module to detect a failure type when certain error patterns are observed, such as repeated connection failures or error rates exceeding a threshold. Server queries incident histories from the information storage apparatus to compute an estimated recovery time based on historically similar incidents. Server constructs a structured record that includes failure type, affected subsystem, estimated recovery time, and an impact scope. Server generates a prompt sentence such as:

“There is an ongoing failure in a system that controls door access. The failure type is a connection failure. The estimated recovery time is 90 minutes. Generate a short notification message for end users that explains the situation in simple terms and clearly states that the estimated recovery time is 90 minutes.”

Server sends this prompt to the generative AI model, obtains a failure notification text, applies adjustments for clarity and consistency, and distributes the text to many terminals via a notification service. This embodiment reduces communication load on support staff and network resources because end users receive precise and consistent information automatically, and fewer redundant inquiries are submitted.

These embodiments provide technical improvements over conventional systems by changing how the server processor internally represents and processes data. Instead of merely applying fixed templates to isolated user inputs, server constructs a unified structured representation that combines logs, history, user intent, and emotion. This representation is then used to condition the generative AI model through a carefully constructed prompt sentence. Because the prompt sentence embeds structured fields that are not directly observable in the user's input, the generative model can generate responses that reflect up-to-date technical state and learned response policies. This reduces the number of dialog turns required to resolve an issue, thereby decreasing CPU time and bandwidth usage per incident.

Furthermore, the integration of emotion analysis with response generation at the processor level enables dynamic control of expression content and politeness level. The processor uses emotion labels as explicit features that modify prompt sentences and post-processing rules.

This approach is different from simple human-task automation because the processor coordinates multiple machine-learned models (intent, emotion, recovery-time regression) and rule-based components to produce outputs that are not achievable by a single rule set or by manual scripting. From a technical perspective, the combination yields higher accuracy in matching user expectations, as observed through reduced negative feedback and shorter sessions, and also optimizes computational resources by avoiding unnecessary follow-up processing.

Alternative embodiments can vary the architecture of the generative AI model and the supporting modules. In one alternative, server uses a smaller language model fine-tuned on domain texts stored locally, to reduce latency and improve control and reproducibility. In another alternative, server uses a hierarchical prompt construction method, where a first stage builds a high-level outline from structured data, and a second stage expands the outline into full sentences. In yet another alternative, server uses reinforcement learning to adjust response policies, where the reward signal is derived from feedback information and emotion analysis results.

Server may also vary the learning methods. For example, server may use mini-batch stochastic gradient descent with an adaptive learning rate to train the intent and emotion classifiers. Server may use early stopping and regularization to prevent overfitting. Server may apply data augmentation techniques, such as paraphrasing user questions or adding noise to audio features, to increase robustness. These machine-learning operations are executed on the server hardware and change internal parameters that govern inference behavior, thereby improving accuracy without requiring manual rule updates.

The invention is not limited to a specific business domain. Server and terminal can be used in various application environments, such as technical support for industrial equipment, monitoring of safety systems, or assistance in healthcare information systems. In all such environments, the core technical operations—structured integration of heterogeneous data, generation of prompt sentences conditioned on technical and emotional context, and adaptive adjustment of response texts—provide improvements in processing efficiency, accuracy of information delivery, and utilization of communication channels.

Although certain embodiments describe particular frameworks, recognition engines, or hardware configurations, any alternative components that provide equivalent functionality may be used. Server may run on a distributed cluster, multiple terminals may operate concurrently, and generative AI models may be updated or replaced during system operation.

The essential aspect is that server processor coordinates natural language processing, information analysis, emotion analysis, prompt sentence generation, generative AI inference, and response adjustment in a unified architecture that improves computer-implemented dialog and notification functions beyond mere automation of human tasks.

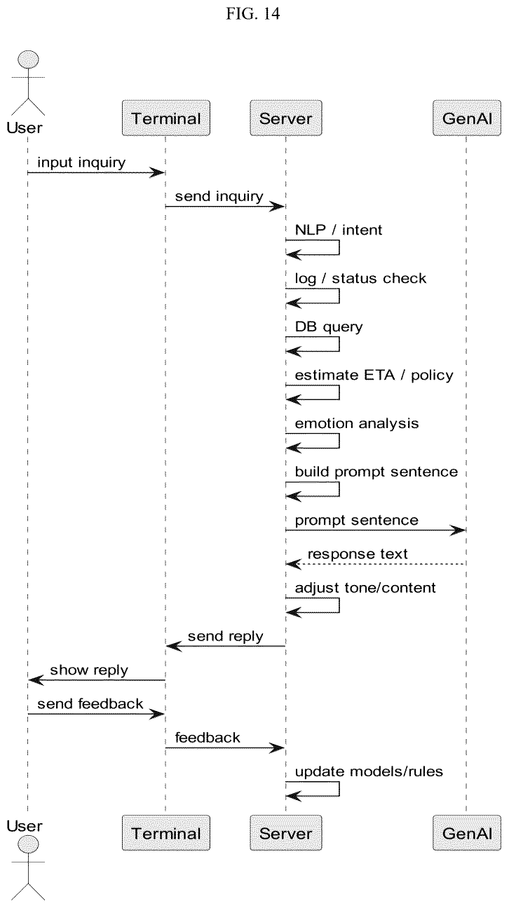

The following describes the processing flow using FIG. 14.

### Step 1:

User operates the terminal to input inquiry information or causes operation status information to be generated.

User types a question or complaint as character string data, or triggers actions (such as accessing a failing service) that cause operation status logs to be produced.

Input: Human speech, key presses, touch operations, or other user actions.

Output: Textual inquiry information stored in terminal memory, and/or operation status information (logs, metrics) generated by software components.

### Step 2:

Terminal transmits inquiry information to the server.

Terminal packages the character string data, user identifier, terminal identifier, and timestamp into a structured message and sends it via a secure communication protocol to the server.

Input: Inquiry text, user ID, session ID, timestamp stored in terminal.

Output: Network packet containing the inquiry information delivered to the server.

### Step 3:

Server receives operation status information and log information from monitored systems.

Server listens on a monitoring interface, collects log records and metrics from a failure monitoring apparatus, and writes them to a log storage region in a structured format.

Input: Raw log lines and metric values streamed from monitored components.

Output: Parsed and time-stamped log information and metrics stored in server memory or a storage device.

### Step 4:

Server analyzes inquiry information using natural language processing technology to determine an inquiry intent.

Server tokenizes the text, performs part-of-speech tagging and syntactic parsing, converts tokens into embedding vectors, and feeds them into an intent classification model to compute a probability distribution over intent categories.

Input: Inquiry text from Step 2.

Output: An inquiry intent label (for example, “troubleshooting,” “status request,” “complaint”) and associated confidence scores.

### Step 5:

Server analyzes operation status information to detect an abnormal state.

Server scans recent log records, applies pattern matching and threshold rules, aggregates error counts over time windows, and determines whether a failure type exists based on statistical criteria.

Input: Log information and metrics from Step 3.

Output: An abnormal state indicator, including a failure type label, severity level, and affected components, or a normal-state indicator if no anomaly is detected.

### Step 6:

Server retrieves information records related to the inquiry intent or abnormal state from an information storage apparatus.

Server formulates database queries using keywords derived from the intent label, failure type, and key tokens, and executes these queries to obtain matching records from configuration tables, manuals, and incident histories.

Input: Inquiry intent and/or abnormal state from Steps 4 and 5.

Output: A set of information elements and past history information, including descriptions, parameters, and previous incident data.

### Step 7:

Server estimates a recovery time or determines a response policy based on information elements and past history information.

Server computes summary statistics of past incidents (such as mean and median resolution times) and optionally applies a regression model that maps features of the present incident to an estimated recovery time; server also selects a response policy (for example, “brief technical response,” “detailed explanation,” “high-politeness apology”) according to failure type and user profile.

Input: Information elements and incident history from Step 6.

Output: An estimated recovery time value and a response policy identifier.

### Step 8:

Server determines an emotional state of the user using emotion analysis.

Server processes the inquiry text with an emotion classifier and optionally processes voice features and facial expression features, then combines these scores to assign an emotion label and intensity values.

Input: Inquiry text from Step 2 and optional multimodal signals provided by the terminal.

Output: An emotional state label (for example, anger, frustration, anxiety, neutrality, joy) and numerical emotion scores.

### Step 9:

Server constructs structured data that integrates technical and user-interaction information.

Server creates a record containing fields for inquiry intent, abnormal state, recovery time, response policy, emotional state, relevant information elements, and user identifiers, and stores this record in memory.

Input: Inquiry intent (Step 4), abnormal state (Step 5), recovery time and response policy (Step 7), emotional state (Step 8), information elements (Step 6).

Output: Unified structured data representing the current context for response generation.

### Step 10:

Server generates a prompt sentence for a generative AI model based on the structured data.

Server selects a prompt template according to response policy and constructs a natural-language instruction by inserting the inquiry text, failure description, estimated recovery time, and emotional state into designated positions in the template.

Input: Structured data from Step 9.

Output: A prompt sentence in natural-language text suitable for conditioning the generative AI model.

### Step 11:

Server inputs the prompt sentence to the generative AI model and generates a response text.

Server sends the prompt sentence to a transformer-based language model, receives token probabilities, and decodes them into a sequence of text tokens that form a draft response; decoding may use algorithms such as greedy decoding, beam search, or nucleus sampling.

Input: Prompt sentence from Step 10.

Output: Generated response text that addresses the inquiry intent and reflects the technical context.

### Step 12:

Server adjusts the expression content and politeness level of the response text based on the emotional state and response policy.

Server examines the generated text for required elements (such as an apology or explicit mention of recovery time), inserts or modifies phrases accordingly, and adjusts lexical choices and sentence forms to match the politeness level specified by the response policy.

Input: Generated response text from Step 11, emotional state and response policy from Steps 7 and 8.

Output: Adjusted response text that satisfies content constraints and tone requirements.

### Step 13:

Server generates notification information including the adjusted response text and prepares it for transmission.

Server encapsulates the response text together with metadata (such as user ID, incident ID, and timestamp) into a message structure appropriate for the chosen communication channel, and serializes this structure into a transmittable format.

Input: Adjusted response text from Step 12 and contextual metadata from structured data.

Output: Notification information object ready for network transmission.

### Step 14:

Server transmits notification information to one or more terminals via a communication network.

Server uses a messaging protocol or notification service to send the serialized notification to the terminal addresses or device tokens associated with the user, and records transmission status in a log.

Input: Notification information from Step 13 and terminal address information stored in user records.

Output: Network messages carrying the notification information delivered to terminals.

### Step 15:

Terminal receives the notification information and presents the response text to the user.

Terminal decodes the received message, extracts the response text, and renders it on a display as a notification, chat message, or overlay; for a wearable terminal, the text is shown in a compact format within the field of view.

Input: Notification message from Step 14.

Output: Visual or audio presentation of the response text on the terminal for the user.

### Step 16:

User reviews the response text and optionally provides feedback through the terminal.

User reads or listens to the response, evaluates its helpfulness, and may select a rating, enter additional comments, or submit a follow-up question via the terminal interface.

Input: Displayed response text from Step 15.

Output: Feedback information, such as ratings, comments, or new inquiry text, stored in the terminal.

### Step 17:

Terminal transmits feedback information to the server.

Terminal packages the feedback, including the associated response identifier and optional emotional reactions, into a structured message and sends it to the server over the communication network.

Input: Feedback information from Step 16.

Output: Feedback message delivered to the server.

### Step 18:

Server updates prompt sentence generation and response text adjustment processes in a learning manner based on feedback and emotion analysis results.

Server correlates feedback with the structured data and response texts used in previous steps, accumulates training samples, and updates parameters of models or rules that govern template selection, phrase insertion, and politeness adjustment, for example by performing gradient-based learning or heuristic rule tuning.

Input: Feedback information from Step 17, emotion analysis results from Step 8, and stored records of prompt sentences and responses.

Output: Updated model parameters and rule sets that modify future prompt sentence generation and response text adjustment behavior.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

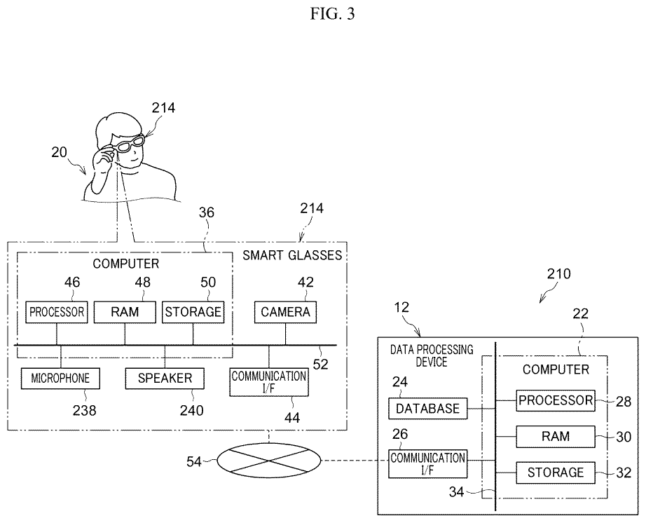

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

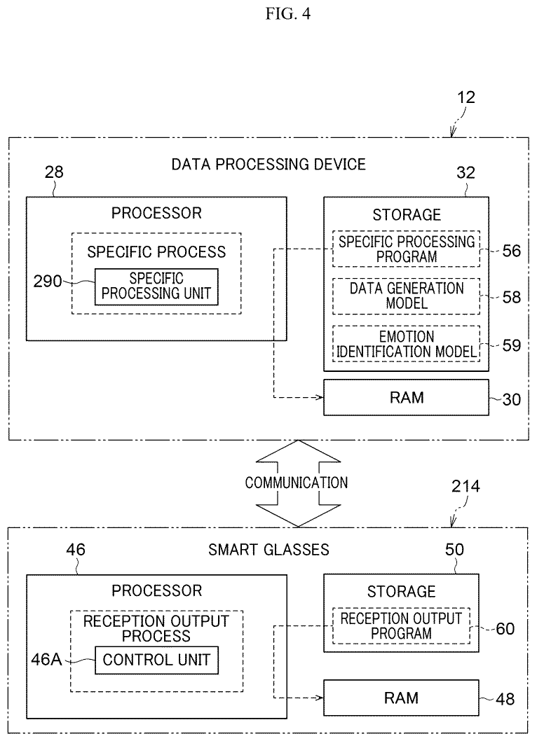

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

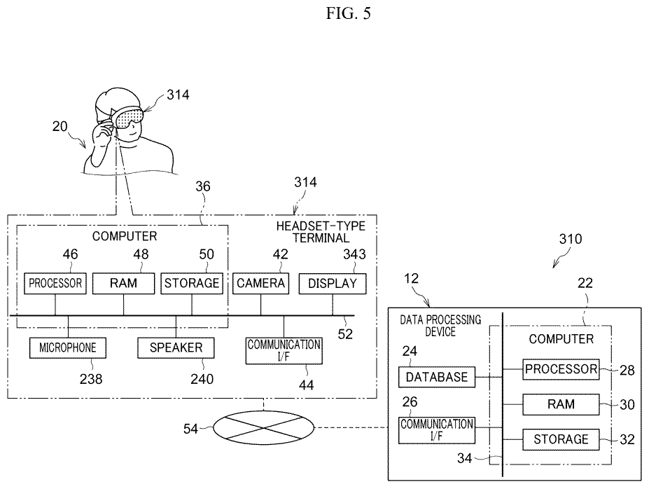

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

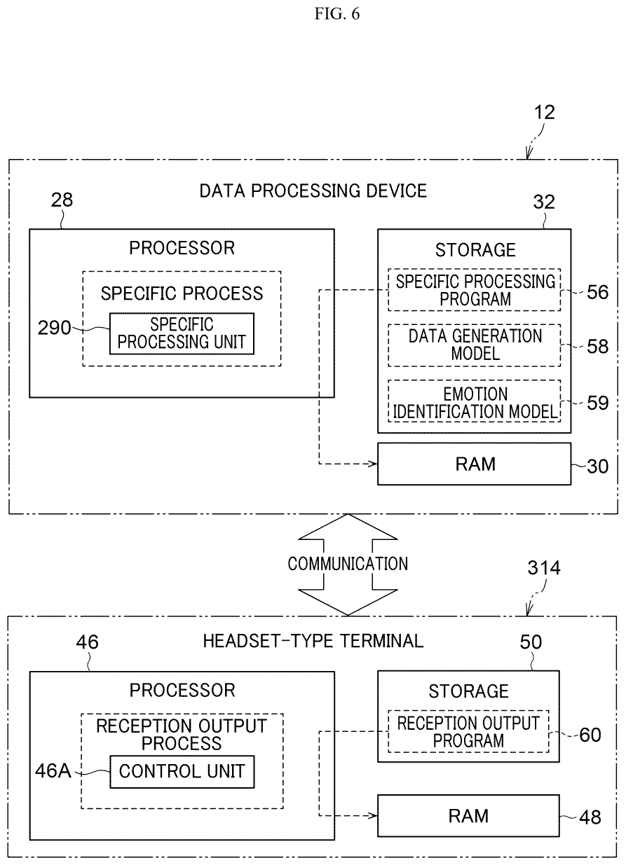

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

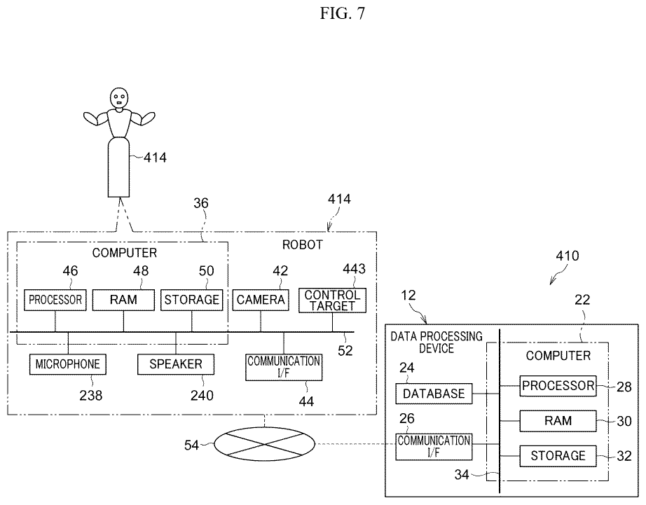

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

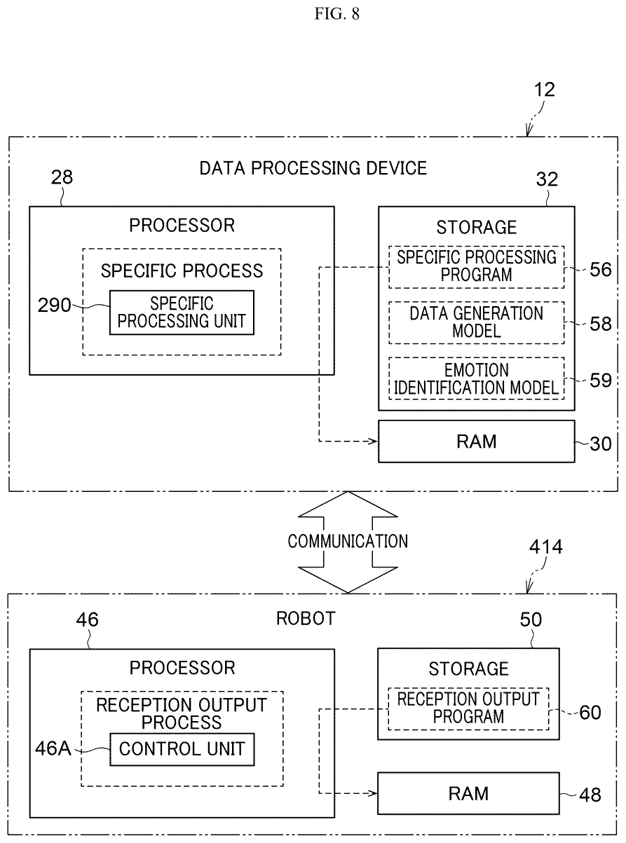

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

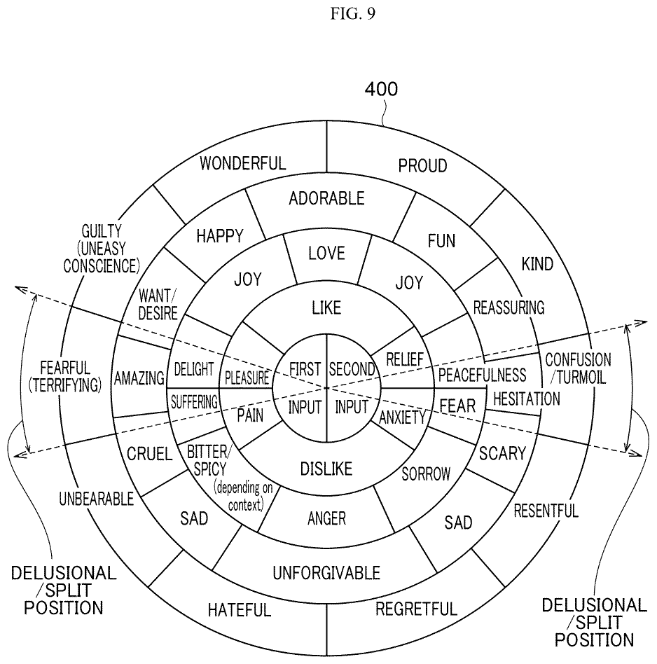

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

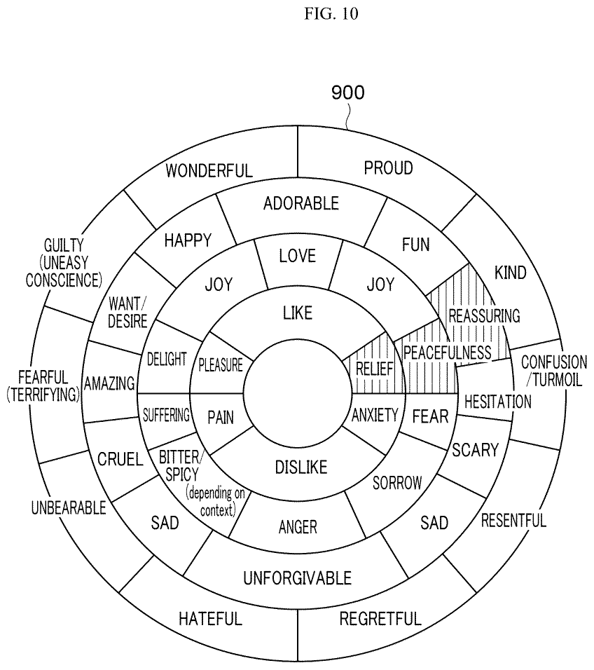

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via a communication network, an inquiry input by a user through a terminal, preprocess the received inquiry by using a natural language processing algorithm, segment the inquiry and convert the inquiry into a code sequence, and generate an analysis result indicating an estimated intent and a target entity of the inquiry,
select, based on the intent and the target entity included in the analysis result, at least one information set stored in an information storage device by using a search condition associated with the intent and the target entity, and acquire related information by using a structured query language,
summarize the acquired related information, extract information elements to be included in an answer, structure the information elements as an internal representation, and generate a prompt sentence including the internal representation and the inquiry, the prompt sentence instructing a generative artificial intelligence model regarding an answer generation method and an expression manner,
input the generated prompt sentence to an external or internal generative artificial intelligence model, cause the generative artificial intelligence model to generate an answer candidate in a natural language form based on the prompt sentence, and select or format an answer satisfying a predetermined condition from the answer candidate,
transmit the selected or formatted answer to the terminal via the communication network and cause the terminal to display the answer on a dialog-type screen,
repeatedly receive additional input from the user regarding the inquiry and the answer, and, at each repetition, update the analysis result, the related information, the prompt sentence, and the answer so as to control a continuous dialog, and
analyze expressions included in the inquiry and the additional input by using an emotion analysis algorithm, change a tone instruction or an explanation-amount instruction included in the prompt sentence according to an analyzed emotion, and adjust the expression manner and a detail level of the answer generated by the generative artificial intelligence model.

### Supplementary 2

The system according to supplementary 1,
wherein the processor is configured to include, in the generated prompt sentence, the related information acquired from the information storage device in an itemized form, thereby instructing the generative artificial intelligence model to generate an explanatory sentence based on the related information and automatically generate an answer to a question from a customer.

### Supplementary 3

The system according to supplementary 1,
wherein the processor is configured to determine, based on the intent and the target entity obtained by analyzing the inquiry using the natural language processing algorithm, an information set to be referenced and instruction content to be given to the generative artificial intelligence model, and generate the prompt sentence reflecting the determined instruction content.

### Application Example 1

### Supplementary 1

A system comprising a processor,
wherein the processor is configured to
receive, via a communication device, a natural language inquiry sentence and identification information associated with the inquiry sentence from a terminal device,
perform morphological analysis and context analysis on the inquiry sentence by using a natural language processing technique to generate structured data including an intention of the inquiry and target information,
generate a search query for an information storage based on the structured data, and acquire, from an information collection stored in the information storage, information related to the inquiry sentence,
generate a prompt sentence including the inquiry sentence, the structured data, and the acquired information, the prompt sentence explicitly instructing a generative artificial intelligence model regarding conditions and constraints for answer generation,
transmit the prompt sentence to an external generative artificial intelligence model providing apparatus and receive, from the generative artificial intelligence model providing apparatus, an answer sentence generated based on the prompt sentence,
examine consistency between contents of the acquired information and the answer sentence, regenerate the prompt sentence such that contents not included in the information collection are not contained in the answer sentence, and retransmit the regenerated prompt sentence to the generative artificial intelligence model to correct the answer sentence,
transmit a corrected answer sentence as response information to the terminal device, store a dialogue history using the response information, and reflect the dialogue history in generation of a subsequent prompt sentence, and
adjust an expression style and a response tone in the prompt sentence based on information related to user emotion transmitted from the terminal device or based on an emotion analysis result with respect to the inquiry sentence and the dialogue history.

### Supplementary 2

The system according to supplementary 1,
wherein the processor is configured to
select, according to an inquiry intention included in the structured data, at least one information storage from among a plurality of types of information storages as the information collection, generate the search query for the selected information storage to acquire the related information, and instruct, within the prompt sentence, the generative artificial intelligence model to use only the acquired related information.

### Supplementary 3

The system according to supplementary 1,
wherein the processor is configured to
sequentially execute, for each inquiry sentence, reception of the inquiry sentence, analysis using the natural language processing technique, searching of the information collection, generation of the prompt sentence, generation of the answer sentence by the generative artificial intelligence model, examination of consistency, and transmission of the answer sentence, store a processing log regarding the sequential execution, and update a generation logic of the prompt sentence and a search condition for the information collection based on the processing log.

### Example 2

### Supplementary 1

A system comprising a processor,
wherein the processor is configured to
receive inquiry information or failure-related information from a user or a customer, analyze received inquiry information by using a natural language processing technique to understand an intention of the inquiry information,
refer to an information storage unit and obtain related information based on an analysis result or the failure-related information,
monitor an operational state of an information processing apparatus or a communication apparatus by using a monitoring function and detect occurrence of a failure in the information processing apparatus or the communication apparatus,
in response to detection of the failure, collect failure information including a failure type, an impact range, an occurrence time, and an estimated recovery time from an observation information source and a storage information source, structure the failure information as structured data, and store the structured data in a storage unit,
generate a prompt sentence, for generation of a response to the inquiry information or a notification regarding the failure, the prompt sentence including the obtained related information or the stored failure information and instructing a generative AI model to generate a natural language response or notification,
input the generated prompt sentence into the generative AI model and cause the generative AI model to generate, in natural language, a response message to the inquiry information or a notification message regarding the failure,
transmit the generated response message or the generated notification message to a user terminal or a customer terminal via a communication function, and
analyze response information or utterance content from the user, estimate an emotional state of the user, and adjust content or expression of the response message or the notification message in accordance with the emotional state.

### Supplementary 2

The system according to supplementary 1,
wherein the processor is configured to
generate the prompt sentence by extracting the failure type, the impact range, the occurrence time, and the estimated recovery time from the stored failure information, and by combining an explanatory text including the extracted items with a condition text instructing the generative AI model to generate a polite and easy-to-understand notification message for the customer, and to cause the generative AI model to automatically generate the notification message.

### Supplementary 3

The system according to supplementary 1,
wherein the processor is configured to
automatically execute generation of the prompt sentence, generation of the notification message by the generative AI model, and transmission of the notification message in response to detection of the failure by the monitoring function, and perform failure notification to the customer without requiring manual operation by an operator.

### Application Example 2

### Supplementary 1

A system comprising a processor,
wherein the processor is configured to
receive inquiry information or operation status information from a user,
analyze character string data and log information included in the received inquiry information or operation status information by using natural language processing technology and information analysis technology, and specify an inquiry intent or an abnormal state,
refer, based on the specified inquiry intent or abnormal state, to information records stored in an information storage apparatus, and acquire related information elements and past history information,
estimate a recovery time or a response policy based on the acquired information elements and the past history information, and generate structured data including a result of the estimation, generate a prompt sentence including an instruction text to be input to a generative AI model, based on the structured data and an analyzed emotional state of the user,
input the generated prompt sentence to the generative AI model and cause the generative AI model to generate a response text according to the inquiry intent or abnormal state and the emotional state of the user,
obtain the generated response text and adjust an expression content or a politeness level of the response text based on the emotional state of the user and a predetermined response policy,
generate notification information including the adjusted response text and transmit the notification information to a user terminal via a network, and
collect feedback information and emotion analysis results transmitted from the user terminal and update, in a learning manner, a prompt sentence generation process or a response text adjustment process.

### Supplementary 2

The system according to supplementary 1,
wherein the processor is configured to
acquire voice information and facial expression information of a user by using a voice acquisition device and an image acquisition device provided in the user terminal, convert the voice information into character string data by using speech recognition technology, estimate an emotional state from the character string data and the facial expression information, and include the estimated emotional state in the prompt sentence so that the generative AI model generates a response text for face-to-face service in a store environment.

### Supplementary 3

The system according to supplementary 1,
wherein the processor is configured to
analyze operation status information and log information obtained from a failure monitoring apparatus to detect occurrence of a failure, estimate a recovery time based on a detected failure type and past failure history, generate a prompt sentence including the estimated recovery time and failure details, cause the generative AI model to generate a failure notification text for end users based on the prompt sentence, and automatically transmit the failure notification text to a plurality of user terminals via a notification service.

What is claimed is:

1. A system comprising:
circuitry configured to:
receive, via a communication interface coupled to a packet-switched network, an inquiry from a terminal device, preprocess the inquiry using a natural language processing algorithm including segmentation, code sequence conversion, and intent estimation, and generate an analysis result indicating at least an estimated intent and a target entity;
select, based on the analysis result, at least one information set from an information storage device, generate a prompt sentence incorporating the selected information set and the analysis result, and input the prompt sentence to a generative AI model to generate an answer; and
analyze an emotional state of the user, adjust the answer based on the analyzed emotional state, and transmit the adjusted answer to the terminal device via the communication interface.

2. The system according to claim 1, wherein the circuitry is configured to preprocess the inquiry by segmenting the inquiry into tokens, converting the tokens into a code sequence, and generating the analysis result indicating at least the estimated intent and the target entity.

3. The system according to claim 2, wherein the circuitry is configured to select at least one information set from the information storage device by matching the estimated intent and the target entity with stored information identifiers, and retrieve the matched information set for inclusion in the prompt sentence.

4. The system according to claim 3, wherein the circuitry is configured to generate the prompt sentence by combining the retrieved information set with an instruction for the generative AI model to generate an answer appropriate to the estimated intent, and input the prompt sentence to the generative AI model.

5. The system according to claim 4, wherein the circuitry is configured to decode an output of the generative AI model to obtain the generated answer as text, postprocess the generated answer to verify relevance to the estimated intent, and filter answers that do not satisfy a relevance threshold.

6. The system according to claim 1, wherein the circuitry is configured to analyze the emotional state of the user by applying an emotion analysis engine to at least one of text content, vocal characteristics, and behavioral patterns in data received from the terminal device via the communication interface.

7. The system according to claim 6, wherein the circuitry is configured to adjust at least one of a tone, a content depth, and a format of the answer based on the analyzed emotional state of the user.

8. The system according to claim 1, wherein the circuitry is configured to detect when the generated answer does not satisfy a confidence threshold, and escalate the inquiry to a human operator interface via the communication interface.

9. The system according to claim 8, wherein the circuitry is configured to record the escalated inquiry and the circumstances of escalation in the information storage device, and use the records to update the information sets available for future prompt sentence generation.

10. The system according to claim 1, wherein the circuitry is configured to update the information storage device with new information received via the communication interface, and regenerate prompt sentences for subsequent inquiries using the updated information sets.

11. The system according to claim 10, wherein the circuitry is configured to apply a feedback loop in which responses to escalated inquiries are incorporated into the information storage device to improve subsequent automated response generation.

12. The system according to claim 1, wherein the circuitry is configured to receive a sequence of inquiries from the terminal device within a session, maintain session context data in the storage device, and incorporate session context data into prompt sentences generated for subsequent inquiries within the session.

13. The system according to claim 12, wherein the circuitry is configured to detect a topic transition in a sequence of inquiries based on the analysis results, update the session context data to reflect the topic transition, and adjust the prompt sentence accordingly.

14. The system according to claim 1, wherein the circuitry is configured to generate a clarification prompt for transmission to the terminal device when the analysis result indicates insufficient confidence in the estimated intent, and generate a refined analysis result based on a clarification response received from the terminal device.

15. The system according to claim 14, wherein the circuitry is configured to incorporate the clarification response into the prompt sentence for the generative AI model, and generate an updated answer based on the refined analysis result.

16. The system according to claim 1, wherein the circuitry is configured to monitor interaction metrics for the terminal device including response acceptance rate and escalation frequency, and use the monitored metrics to periodically update the information sets stored in the information storage device.

17. The system according to claim 16, wherein the circuitry is configured to detect degradation in response quality based on the monitored interaction metrics, and trigger retraining or updating of the generative AI model using accumulated inquiry and response data.

18. A system comprising:
circuitry configured to:
receive, via a communication interface coupled to a packet-switched network, an inquiry from a terminal device, preprocess the inquiry using a natural language processing algorithm to generate an analysis result indicating an estimated intent and a target entity, and select at least one information set from an information storage device based on the analysis result;
generate a prompt sentence incorporating the selected information set and the analysis result, input the prompt sentence to a generative AI model to generate an answer, and analyze an emotional state of the user based on data received from the terminal device; and
adjust the answer based on the analyzed emotional state, transmit the adjusted answer to the terminal device via the communication interface, and update the information storage device based on interaction feedback.

19. The system according to claim 18, wherein the circuitry is configured to detect when the generated answer does not satisfy a confidence threshold, escalate the inquiry to a human operator interface, and incorporate the response from the human operator into the information storage device for use in subsequent prompt sentence generation.

20. A method comprising:
receiving, via a communication interface coupled to a packet-switched network, an inquiry from a terminal device, preprocessing the inquiry using a natural language processing algorithm to generate an analysis result indicating at least an estimated intent and a target entity, and selecting at least one information set from an information storage device based on the analysis result;
generating a prompt sentence incorporating the selected information set and the analysis result, inputting the prompt sentence to a generative AI model to generate an answer; and
analyzing an emotional state of the user, adjusting the answer based on the analyzed emotional state, and transmitting the adjusted answer to the terminal device via the communication interface.
